(19) United States
(12) Patent Application Publication
(10) Pub. No.: US 2024/0278468 A1
(43) Pub. Date: Aug. 22, 2024

(54) SLIDING MECHANISM, UNDERCUT PROCESSING MECHANISM, AND MOLDING DIE

(71) Applicant: Technocrats Corporation, Hiroshima (JP)

(72) Inventor: Masanori Sorimoto, Fuchu-cho, Aki-gun, Hiroshima (JP)

(21) Appl. No.: 18/568,265

(22) PCT Filed: Sep. 7, 2022
(86) PCT No.: PCT/JP2022/033503

§ 371 Date: Dec. 7, 2023

(30) Foreign Application Priority Data
Sep. 15, 2021 (WO) PCT/JP2021/033824

(51) Int. Cl. B29C 45/44; B29C 33/44

(52) U.S. Cl. CPC B29C 45/44; B29C 33/44

(57) ABSTRACT

A sliding mechanism includes a slider movable along a predetermined direction, an interlock member, an inner holder, and an outer holder. The interlock member is movable in a first direction in engagement with the slider. The interlock member, the inner holder, and the outer holder each include guiding sections to guiding the slider along the predetermined direction. The outer holder includes a guiding section guiding the inner holder along the first direction, and the inner holder can move in such a way that the inner holder is displaced relative to the outer holder.

### FIELD OF THE INVENTION

The present invention relates to a sliding mechanism, as well as an undercut processing mechanism and a molding die, each utilizing the sliding mechanism.

### BACKGROUND ART

In the field of molding die for molding an article having an undercut portion, a number of undercut processing mechanisms have been developed to address different shapes of undercut portions. Such undercut processing mechanisms often feature an ability to be compactly integrated (see, for example, Patent Documents 1 and 2).

The undercut processing mechanism described in Patent Document 1 includes a slider which supports an undercut portion molding core, a base member to which the slider is slidably coupled, and a holder. The slider is displaced in an interlocking manner with an ejector mechanism to release an undercut portion.

The undercut processing mechanism described in Patent Document 2 includes a holder which is movable along a demolding direction of a molded article, a slide piece which molds an undercut portion, and a carrier piece which slidably carries the slide piece, and is configured such that the holder moves in the demolding direction of the molded article to displace the slide piece in such a direction that allows the undercut portion to be released during a demolding phase for the molded article.

### RELATED DOCUMENT

### [Patent Document]

[Patent Document 1] JP Laid-open Patent Publication No. 2011-68040
[Patent Document 2] JP Laid-open Patent Publication No. 2018-140623

### SUMMARY OF THE INVENTION

In case of a molded article having a complex structure such that a portion of the molded article constitutes an undercut portion and the undercut portion further has an undercut portion, it has conventionally been the practice to mold a main body of the article and a separate component containing the undercut portions and join them together to form a complete, molded article. However, this process involves a number of steps and is therefore time-consuming. Hence, there is a demand for a molding die that can be used to mold a one-piece article having this type of complex structure.

A molding die that is used to mold articles having a complex structure generally comes in a large size, because of a large number of components in the die as well as the presence of complicated mechanisms required to slidably displace a core member. At the same time, there is an increasing need for a more compact design for undercut processing mechanisms and molding dies integrated with such a mechanism. Simple and compact design of components such as a mechanism for slidably displacing a core member allows size-reduction of undercut processing mechanism and molding die which includes those components. Therefore, there is a strong demand for sliding mechanism of simple and compact design.

An object of the present invention is to provide a sliding mechanism that can be configured in a compact size, as well as an undercut processing mechanism and a molding die, each of which is compact and uses the sliding mechanism to thereby allow for easy releasing of complex undercut portion features.

The present invention provides a sliding mechanism including: a slider movable along a predetermined direction; an interlock member which is movable along a first direction in engagement with the slider; an inner holder movable along the first direction and including a guiding section configured to guide the slider along the predetermined direction; and an outer holder including a guiding section configured to guide the slider along the predetermined direction and a guiding section configured to guide the inner holder along the first direction, wherein the inner holder is configured to move in such a way that the inner holder is displaced relative to the outer holder.

In the sliding mechanism according to the present invention, the inner holder may slidably receive a part or entirety of the slider, and the outer holder may slidably receive a part or entirety of the inner holder.

In the sliding mechanism according to the present invention the inner holder and the outer holder may be configured to cooperate to slidably receive a part or entirety of the slider.

In the sliding mechanism, the predetermined direction may be different from the first direction.

In the sliding mechanism according to the present invention, the slider may include two or more slide members, and the predetermined direction may be different among at least two of the slide members.

In the sliding mechanism according to the present invention, the interlock member and the inner holder may be configured to be movable at same timings, at same speeds, and for same distances.

In the sliding mechanism according to the present invention, the interlock member may be fixed to the inner holder or may be integrated with the inner holder as one piece construction.

In the sliding mechanism according to the present invention, the interlock member and the inner holder may be configured to move together in an interlocking manner up to a predefined first point. Once the first point is reached, the interlock member and the inner holder may move relatively at different speeds or the interlock member may be stopped while only the inner holder may be configured to be movable further.

The sliding mechanism according to the present invention may further include, in place of the outer holder, a guide piece which is in slidable engagement with the slider and which includes a guiding section configured to guide the slider along the predetermined direction.

The sliding mechanism according to the present invention may be assembled as a single unit.

An undercut processing mechanism of the present invention includes the aforementioned sliding mechanism which is configured to disengage a mold portion from an undercut portion, wherein the mold portion is configured to mold the undercut portion in an article to be molded.

The undercut processing mechanism according to the present invention may be configured to be installed to and used with a molding die that molds an article having an undercut portion, wherein the first direction is a demolding direction of the molded article, the predetermined direction is a releasing direction of the undercut portion, the slider comprises a slide piece which includes the mold portion configured to shape the undercut portion, the interlock member comprises a carrier piece in slidable engagement with the slide piece, movable along the demolding direction of the molded article, and including a guiding section configured to guide the slide piece along the releasing direction of the undercut portion, wherein the slide piece is configured to move in conjunction with movements of the inner holder and the carrier piece in the demolding direction of the molded article, so as to decouple itself from the undercut portion.

In the undercut processing mechanism according to the present invention, the undercut portion may include a first undercut portion which defines a releasing direction that forms a crossing angle to the demolding direction of the molded article, and a second undercut portion which defines a releasing direction that is different from the demolding direction of the molded article and the releasing direction of the first undercut portion, wherein the slide piece includes a first slide piece and a second slide piece, wherein the first slide piece has a mold portion configured to shape the first undercut portion, and the second slide piece has a mold portion configured to shape the second undercut portion.

In the undercut processing mechanism according to the present invention, the first undercut portion may form a projection extending along a direction that forms a crossing angle to the demolding direction of the molded article. The second undercut portion may be provided in or at the first undercut portion.

In the undercut processing mechanism according to the present invention, the second slide piece may have a mold portion configured to shape a part of the first undercut portion, and the first slide piece and the second slide piece may be configured to cooperate to shape the first undercut portion.

In the undercut processing mechanism according to the present invention, the guiding sections provided at the inner holder and the outer holder for guidance along the predetermined direction may be configured to guide the first slide piece in such a direction that decouples the first slide piece from the first undercut portion, wherein the inner holder may be configured to move in the demolding direction of the molded article so as to eject the molded article and cause the first slide piece to move away from the first undercut portion to thereby decouple the first slide piece from the first undercut portion.

In the undercut processing mechanism according to the present invention, the releasing direction of the second undercut portion may form a crossing angle to the releasing direction of the first undercut portion, and the inner holder and the carrier piece may be configured to move in the demolding direction of the molded article so as to cause a movement of the second slide piece in the demolding direction of the molded article, during which the second slide piece is decoupled from the second undercut portion.

In the undercut processing mechanism according to the present invention, the first slide piece may include a guiding section configured to guide a movement of the second slide piece in such a way that causes the second slide piece to decouple itself from the second undercut portion.

In the undercut processing mechanism according to the present invention, the second undercut portion may include one or at least two undercut portions, the second slide piece may comprise one or at least two mold pieces configured to shape the one or at least two undercut portions, the carrier piece may comprise a guiding section configured to guide a movement of the mold piece or pieces so as to decouple the mold piece or pieces from the second undercut portion, and the inner holder and the carrier piece may be configured to move in the demolding direction of the molded article so as to cause the mold piece or pieces to move in such a way that decouples itself or themselves from the second undercut portion.

In the undercut processing mechanism according to the present invention, the second slide piece may comprise two or more split pieces, at least two of which may be configured to move along different directions that are also different from a direction or directions along which the inner holder and the carrier piece move.

In the undercut processing mechanism according to the present invention, the second slide piece may comprise a plurality of split pieces which may be configured to move in such a way to shrink and allow the undercut portion or undercut portions to be released.

In the undercut processing mechanism according to the present invention, the carrier piece and the inner holder may be configured such that the the carrier piece and the inner holder move together in an interlocking manner in the demolding direction of the molded article until the second slide piece decouples from the second undercut portion, and that once the second slide piece decouples from the second undercut portion, the carrier piece and the inner holder move in the demolding direction of the molded article relatively at different speeds, or the carrier piece stops and only the inner holder further moves in the demolding direction of the molded article.

In the undercut processing mechanism according to the present invention, the first slide piece may concurrently serve as the second slide piece such that the first slide piece includes both the mold portion configured to shape the first undercut portion and the mold portion configured to shape the second undercut portion.

In the undercut processing mechanism according to the present invention, the inner holder and the first slide piece may provide a coupling feature defined by a concave groove and a convex stripe fitted slidably in the concave groove such that the inner holder and the first slide piece are slidably coupled to each other through the coupling feature, and the inner holder and the outer holder may provide a coupling feature defined by a concave groove and a convex stripe fitted slidably in the concave groove such that the inner holder and the outer holder are slidably coupled to each other through the coupling feature.

The undercut processing mechanism according to the present invention may be assembled as a single unit.

The present invention also provides a molding die (molding die assembly), which includes the aforementioned undercut processing mechanism.

The present invention also provides a molded article including a main body and an undercut portion, wherein the undercut portion includes a first undercut portion which projects in a direction that forms a crossing angle to a demolding direction of the molded article, and a second undercut portion which is provided to the first undercut portion and which defines a releasing direction that is different from a releasing direction of the first undercut portion, the main body of the article and the undercut portion are integrally molded in a molding die such that a cross-section of the molded article at a boundary between the main body of the article and a region of the first undercut portion contains no seam mark present therebetween.

### Effects of the Invention

The present invention can provide a sliding mechanism that can be configured in a compact size, as well as an undercut processing mechanism and a molding die, each of which is compact and uses the sliding mechanism to thereby allow for easy releasing of complex undercut portion features. Further, by making use of an undercut processing mechanism and a molding die according to the present invention, molded articles having a complex structure with an undercut portion in a portion of the molded article and a further undercut portion in or at the undercut portion itself can be readily produced.

### BRIEF DESCRIPTION OF THE DRAWINGS

FIG. 1 shows a cross sectional view of main parts of a molding die 1, according to a first embodiment of the present invention.

FIG. 2 shows a cross sectional view of an undercut processing mechanism 11 integrated into the molding die 1 during a molding phase, according to the first embodiment of the present invention.

FIG. 3 shows a cross sectional view of the undercut processing mechanism 11 integrated into the molding die 1 during an ejection phase for a molded article P1, according to the first embodiment of the present invention.

FIG. 4 shows an exploded view of components of the undercut processing mechanism 11 integrated into the molding die 1, according to the first embodiment of the present invention.

FIG. 5 shows a cross sectional view of an undercut processing mechanism 12 during a molding phase, according to a second embodiment of the present invention.

FIG. 6 shows a cross sectional view of the undercut processing mechanism 12 during an ejection phase for a molded article P1, according to the second embodiment of the present invention.

FIG. 7 shows a cross sectional view of an undercut processing mechanism 13 during a molding phase, according to a third embodiment of the present invention.

FIG. 8 shows a cross sectional view of the undercut processing mechanism 13 during an ejection phase for a molded article P3, according to the third embodiment of the present invention.

FIG. 9 shows a cross sectional view of an undercut processing mechanism 14 during a molding phase, according to a fourth embodiment of the present invention.

FIG. 10 shows a cross sectional view of the undercut processing mechanism 14 during an ejection phase for a molded article P4, according to the fourth embodiment of the present invention.

FIG. 11 shows a cross sectional view of an undercut processing mechanism 15 during a molding phase, according to a fifth embodiment of the present invention.

FIG. 12 shows a cross sectional view of the undercut processing mechanism 15 during an ejection phase for a molded article P5, according to the fifth embodiment of the present invention.

FIG. 13 shows an exploded view of components of the undercut processing mechanism 15, according to the fifth embodiment of the present invention.

FIG. 14 shows a cross sectional view of an undercut processing mechanism 16 during a molding phase, according to a sixth embodiment of the present invention.

FIG. 15 shows a cross sectional view of the undercut processing mechanism 16 during an ejection phase for a molded article P4, according to the sixth embodiment of the present invention.

FIG. 16 shows a cross sectional view of an undercut processing mechanism 17 during a molding phase, according to a seventh embodiment of the present invention.

FIG. 17 shows a cross sectional view of the undercut processing mechanism 17 during an ejection phase for a molded article P30, according to the seventh embodiment of the present invention.

FIG. 18 shows another cross sectional view of the undercut processing mechanism 17 during the ejection phase for the molded article P30, according to the seventh embodiment of the present invention.

FIGS. 19A to 19E show a set of diagrams which illustrate example articles that can be molded with the use of an undercut processing mechanism and a molding die according to the present invention.

### DESCRIPTION OF EMBODIMENTS

A sliding mechanism according to the present invention includes a slider movable along a predetermined direction, an interlock member in engagement with the slider, movable along a first direction, and including a guiding section configured to guide the slider along the predetermined direction, an inner holder movable along the first direction and including a guiding section configured to guide the slider along the predetermined direction, and an outer holder including a guiding section configured to guide the slider along the predetermined direction and a guiding section configured to guide the inner holder along the first direction, wherein the inner holder is configured to move in such a way that the inner holder is displaced relative to the outer holder.

What follows is a more particular explanation of the configurations, features, and effects and benefits of a sliding mechanism according to the present invention, in the context of the use of the sliding mechanism in an undercut processing mechanism and in the context of the undercut processing mechanism itself. A sliding mechanism according to the present invention is used in molding dies 1 and undercut processing mechanisms 11, 12, 13, 14, 15, 16, 17 according to first to seventh embodiments of the present invention.

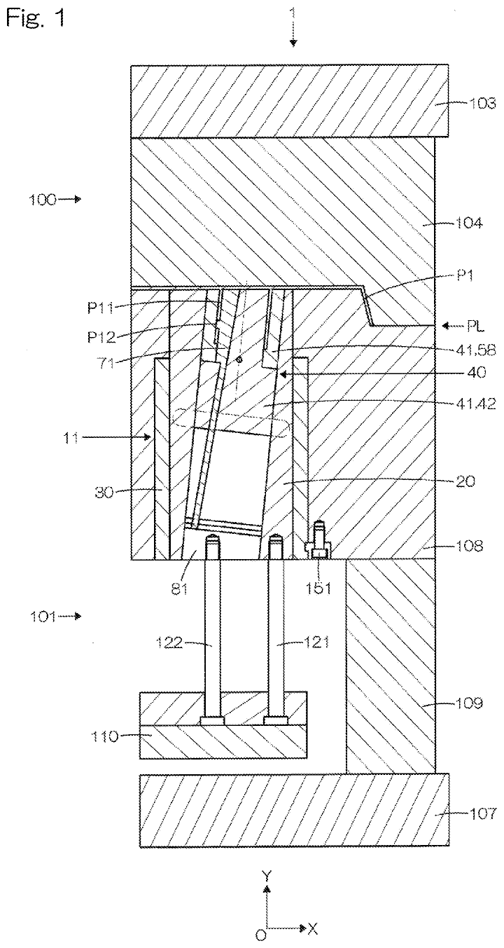

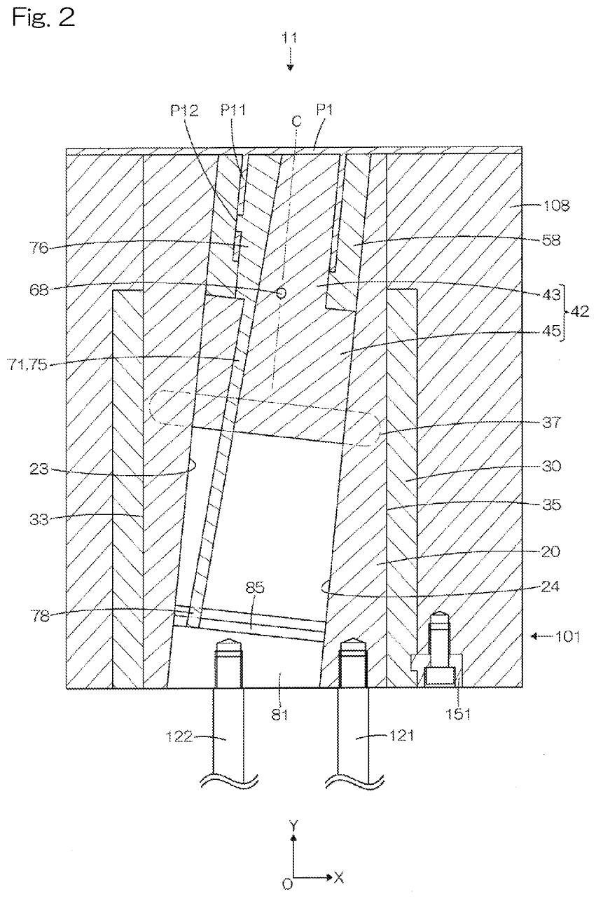

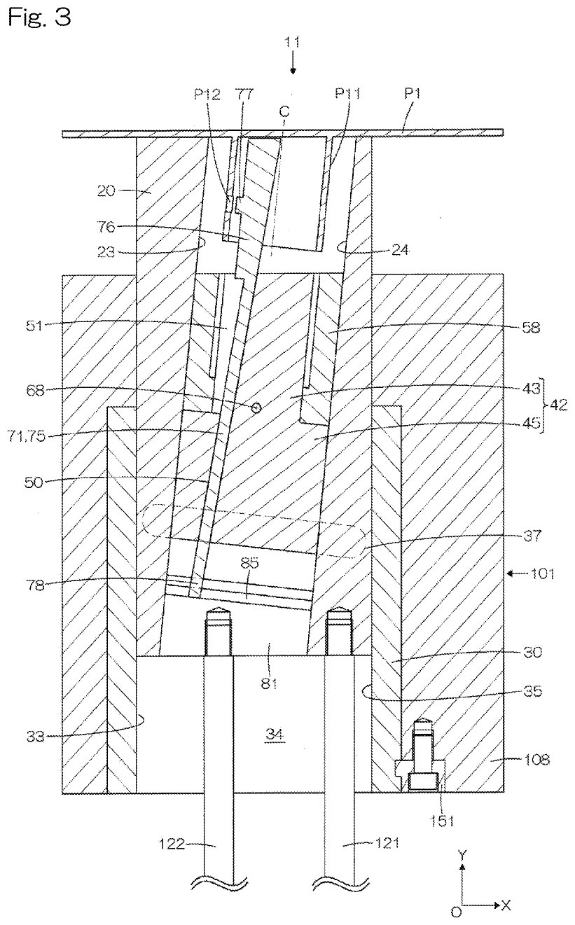

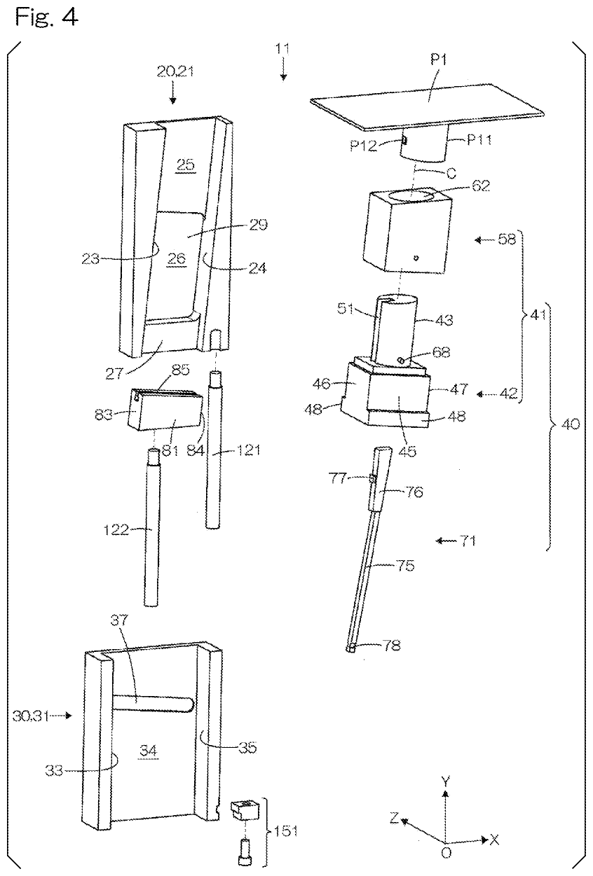

FIG. 1 shows a cross sectional view of main part of a molding die 1, according to a first embodiment of the present invention. FIG. 2 shows a cross sectional view of an undercut processing mechanism 11 integrated into the molding die 1 during a molding phase for a molded article P1, according to the first embodiment of the present invention, while FIG. 3 shows a cross sectional view of the same during an ejection phase for the molded article P1. FIG. 4 shows an exploded view of components of the undercut processing mechanism 11 integrated into the molding die 1, according to the first embodiment of the present invention.

Among FIGS. 1 to 4, FIGS. 1 to 3 illustrate front view as viewed from the front towards a plane containing an x-axis and a y-axis. In addition, the terms upward, upper, and the like denote a positive direction along the y-axis, the terms downward, lower, and the like denote a negative direction along the y-axis, the terms right and the like denote a positive direction along the x-axis, the terms left denotes a negative direction along the x-axis, the terms far and rear denote a positive direction along a z-axis, the terms close and front denote a negative direction along the z-axis, a vertical direction on a front view runs parallel to the directions along the y-axis, and a horizontal direction on a front view runs parallel to the directions along the x-axis. The x-axis, y-axis, and z-axis in this context correspond to an x-axis, a y-axis, and a z-axis in three-dimensional orthogonal coordinates, respectively. In the instant embodiment, a parting line PL extends parallel to the x-axis, a demolding direction of the molded article P1 extends parallel to the y-axis, and longitudinal directions (or widthwise directions) of an inner holder 20 and an outer holder 30 extend parallel to the x-axis, when viewed in a front view. Essentially, these orientations of the x-axis, y-axis, and z-axis and of the upper, lower, left, and right also apply to the rest of the embodiments.

A molding die 1 according to the first embodiment of the present invention has a configuration analogous to that of a known injection molding die in that it includes a fixed die 100 for shaping the top side of an article P1 being molded (see FIG. 1) and a movable die 101 for shaping the underside of the article P1 being molded, but differs from a known injection molding die in that it includes an undercut processing mechanism 11.

As with a known injection molding die, the fixed die 100 of the molding die 1 according to the instant embodiment includes a stationary mounting plate 103, a fixed die plate 104, a locating ring (not shown), and a sprue bushing (not shown), among others. The movable die 101 of the molding die 1 according to the instant embodiment includes a movable mount plate 107, a movable die plate 108, a spacer block 109, an ejector plate 110, an ejector pin (not shown), a return pin (not shown), a spring (not shown), and an ejector rod (not shown), among others. At the end of a molding and die opening cycle, the ejector plate 110 moves in a demolding direction of the molded article P1 (or the upward direction in FIG. 1) for the ejection of the molded article P1 by means of the ejector pin. Note that the above-listed components will not be treated in the discussion as they are analogous to those in a known injection molding die.

The molding die 1 according to the instant embodiment also includes the undercut processing mechanism 11 integrated into the movable die 101 to allow releasing of undercut portions P11, P12. An inner holder ejector pin 121 for extension of the inner holder 20 and a carrier piece ejector pin 122 for pushing a carrier piece 81 of the undercut processing mechanism 11—each of which will be later discussed—are arranged on the ejector plate 110 in an upright manner together with the ejector pin (not shown) which is dedicated to ejection of the molded article P1.

The undercut processing mechanism 11 shapes the undercut portions P11, P12 and comes out of engagement with the undercut portions P11, P12 during a demolding phase (or an ejection phase) for the molded article P1 to thereby allow the molded article P1 to be demolded from the molding die 1. The molded article P1 according to the instant embodiment includes two different shapes of undercut portions.

The undercut portion P11 is in the form of a cylindrical boss P11 which forms a projection extending from the underside of the molded article P1 along a direction that forms an crossing angle to the demolding direction of the molded article P1 (which runs in a positive direction along the y-axis in FIG. 1). The undercut portion P12 is in the form of a hole P12 which is provided on a given location of the cylindrical boss P11 and which defines a releasing direction that is different from a releasing direction of the cylindrical boss P11. In the instant embodiment, the undercut portion P11 or the cylindrical boss P11 represents a first undercut portion, while the undercut portion P12 or the hole P12 represents a second undercut portion.

The undercut processing mechanism 11 includes the inner holder 20 which slidably receives a part or entirety of a slide piece 40, the outer holder 30 which slidably receives a part or entirety of the inner holder 20, the slide piece 40 which is in slidable engagement with the inner holder 20 and which shapes the undercut portions P11, P12, and the carrier piece 81 which is in engagement with and slidably carries a second slide piece 71. During the demolding phase for the molded article P1, the inner holder 20 and the carrier piece 81 are configured to move in the demolding direction of the molded article P1 so as to cause the slide piece 40 to move in such a direction that decouples the slide piece 40 from the undercut portions P11, P12.

The slide piece 40, the carrier piece 81, the inner holder 20, and the outer holder 30 in the undercut processing mechanism 11 according to the instant embodiment correspond, respectively, to a slider, an interlock member, an inner holder, and an outer holder of a sliding mechanism according to the present invention. Also, a first slide piece 41 and the second slide piece 71 as components of the slide piece 40 correspond to slide members of a sliding mechanism according to the present invention.

Further, engagement grooves 85 provided in the carrier piece 81, inner wall surfaces 23, 24 of the inner holder 20, and guide grooves 37 and inner wall surfaces 33, 35 provided in and on the outer holder 30 correspond, respectively, to a guiding section provided at an interlock member, a guiding section provided at an inner holder, a guiding section provided at an outer holder and configured to guide a slider along a predetermined direction, and a guiding section provided at the outer holder and configured to guide the inner holder along a first direction in a sliding mechanism according to the present invention. Furthermore, the demolding direction of the molded article P1 and the releasing directions of the undercut portions in the undercut processing mechanism 11 according to the instant embodiment correspond, respectively, to a first direction and a predetermined direction in a sliding mechanism according to the present invention.

The inner holder 20 is coupled to the ejector plate 110 through the inner holder ejector pin 121 and thereby serves as a movable holder that can be advanced and retracted along the demolding direction of the molded article P1 while being integrated with the ejector plate 110. The inner holder 20 is accommodated in the outer holder 30 and embedded in the movable die plate 108 of the movable part 101.

The inner holder 20 is formed of two symmetrical, half-split holders (half-split components of the holder) having a U-shaped cross section (with corners in straight angle) and mated with each other to represent a square tube. The resulting internal space of the inner holder 20 defines a housing volume 29 for receiving the slide piece 40 and the carrier piece 81. In the instant embodiment, the slide piece 40 and the carrier piece 81 are received completely in the inner holder 20 in a die clamping position, although the slide piece 40 and the carrier piece 81 may be partially received instead.

Although the inner holder 20 of the instant embodiment is formed of two symmetrical half-split holders 21, the inner holder 20 may alternatively be formed of two asymmetrical components or formed of one or at least three components. Examples of the outer profile of the inner holder 20 include, in a non-limiting manner, a cylindrical shape and a polygonal tube shape, in addition to a generally cuboidal shape according to the instant embodiment. Shapes that are easy to produce and assemble are preferred. Selection thereof can be made, as appropriate, according to the shape of an article to be molded. The same applies to inner holders used in undercut processing mechanisms according to the rest of the embodiments of the present invention.

Left and right inner sides (or the inner wall surfaces) 23, 24 of the inner holder 20 extend parallel to each other and define slopes that run parallel to a central axis C of the cylindrical element P11 when viewed in a front view. The left and right inner wall surfaces 23, 24 serve as a guide that guides the first slide piece 41 in such a way that decouples itself from the cylindrical boss P11 during the demolding phase for the molded article P1 and can even be considered to be a limiter that delimits the direction of movement of the first slide piece 41 in a way that forces the first slide piece 41 to decouple from the cylindrical boss P11. An inner wall surface 25 of an upper part on a rear side and an inner wall surface (not shown) of the upper part on a front side of the inner holder 20 define slide surfaces which are in slidable contact with a rear side and a front side of the first slide piece 41.

Openings 26 are formed in the center portions of the front side and the rear side of the inner holder 20. The openings 26 allow convex stripes 48 provided on the first slide piece 41 to extend out of the inner holder 20 and engage with the guide grooves 37 provided in the outer holder 30. The inner holder 20 has a lower part 27 which has a greater wall thickness, in the rear side wall and front side wall, than the upper part of the inner holder 20 such that the carrier piece 81 is received in the lower parr 27 without forming any clearances.

The inner holder 20 is shaped and positioned so as to put its top side in flush with a top surface of the movable die plate 108 during a die clamping phase for the molding die 1 and in contact with the underside of the article P1 being molded during the molding phase for the same. Thus, the inner holder 20 shapes a part of the article P1 being molded during the molding phase and ejects the molded article P1 during the demolding phase for the same. The inner holder 20 is shaped and positioned so as to form no clearances between the top side of the inner holder 20 and the top surface of the movable die plate 108 during the die clamping phase in order to avoid a molding defect on the molded article P1. Another component may be present between the article P1 to be molded and the inner holder 20, provided that a movement of the inner holder 20 is not hindered.

The outer holder 30 is a stationary holder which slidably receives the inner holder 20 and which is fixedly embedded in the movable die plate 108 by means of a fastener 151. The outer holder 30 is formed of two symmetrical, half-split holders 31 having a U-shaped cross section (with straight corner angles) and mated with each other to represent a square tube. The outer holder 30 may have any length (in a positive direction along the y-axis), as long as at least a part of the inner holder 20 can be slidably received therein.

While the outer holder 30 of the instant embodiment is formed of the two symmetrical half-split holders 31, the outer holder 30 may alternatively be formed of two asymmetrical components or formed of one or at least three components. Examples of the outer profile of the outer holder 30 include, in a non-limiting manner, a cylindrical shape and a polygonal tube shape, in addition to a generally cuboidal shape according to the instant embodiment. Shapes that are easy to produce and assemble are preferred. Selection thereof can be made, as appropriate, according to the shape of the article to be molded. The same applies to outer holders used in undercut processing mechanisms according to the rest of the embodiments of the present invention.

The outer holder 30 has inner wall surfaces 33, 34, 35 that define slide surfaces in contact with the outer wall surfaces of the inner holder 20, such that the inner holder 20 moves along the demolding direction of the molded article P1 by sliding on the inner wall surfaces 33, 34, 35 of the outer holder 30. The inner wall surface on a front side and the inner wall surface 34 on a rear side of the outer holder 30 are provided with guide grooves 37 along which the first slide piece 41 can be guided in such a way to decouple the first slide piece 41 from the cylindrical boss P11. The guide grooves 37 define slanting grooves which extend perpendicular to the central axis C of the cylindrical boss P11 when viewed in a front view.

The positions and angles of the guide grooves 37 are not limited to those perpendicular to the central axis C of the cylindrical boss P11 when viewed in a front view. The guide grooves 37 can be configured in any manner desired, as long as they can guide the first slide piece 41 in such a way that decouples the first slide piece 41 from the cylindrical boss P11. The same applies to guide grooves used in undercut processing mechanisms according to the rest of the embodiments of the present invention.

The walls of the inner holder 20 and/or the outer holder 30 of the undercut processing mechanism 11 according to the first embodiment may be provided in part with a slit, a cutout, and/or a hole, provided that the walls serve their intended, underlying functions. For instance, the left and right walls of the inner holder 20 define the inner wall surfaces 23, 24 which serve as a guide that guides the first slide piece 41 in such a way to decouple the first slide piece 41 from the cylindrical boss P11. In this case, the left and right walls of the inner holder 20 may also be provided in part with a slit, a cutout, and/or a hole, provided that the inner wall surfaces 23, 24 function as a guide that guides the first slide piece 41 in such a way to decouple the first slide piece 41 from the cylindrical boss P11. The slit, cutout, and/or hole may be present in a fragmentary manner in the inner wall surfaces 23, 24, or the inner wall surface 23, 24 may be split to tow or more components.

The slide piece 40 includes the first slide piece 41 which shapes the cylindrical boss P11 and the second slide piece 71 which principally shapes the hole P12 provided in the cylindrical boss P11. The first slide piece 41 includes an inner-surface molding piece 42 which shapes an inner side of the cylindrical boss P11 and an outer-surface molding piece 58 which shapes an outer side of the cylindrical boss P11.

The inner-surface molding piece 42 includes a cylinder-shaped mold portion 43 which shapes the inner side of the cylindrical boss P11 and a block-shaped base element 45 located below the mold portion 43. The inner-surface molding piece 42 has a left part (in a negative direction along the x-axis) that is provided with a guide channel 50 and a valley (recess) 51, in both of which the second slide piece 71 fits in a slidable manner. The guide channel 50 and the valley 51 serve as a guide that receives the second slide piece 71 and that guides the second slide piece 71 in such a way to decouple itself from the hole P12. The guide channel 50 is in the form of a through bore penetrating through the base element 45.

The base element 45 has a width (in directions along the x-axis) that corresponds to the distance between the left and right inner wall surfaces 23, 24 of the inner holder 20, while the base element 45 has left and right side surfaces 46, 47 that extend parallel to the inner wall surfaces 23, 24 of the inner holder 20, respectively. Thus, the inner-surface molding piece 42 slidably fits in the inner holder 20 without forming any clearances. In addition, the base element 45 on a front side and a rear side is provided with the convex stripe 48 which are slidably fitted in the guide grooves 37 in the outer holder 30.

The outer-surface molding piece 58 represents a block-shaped piece centrally having a mold surface 62 which shapes the outer surface of the cylindrical boss P11. The outer-surface molding piece 58 is coupled to the inner-surface molding piece 42 through a coupling pin 68 such that a bottom face of the outer-surface molding piece 58 is in contact with an upper face of the inner-surface molding piece 42. In this position, a space that corresponds to the cylindrical boss P11 is defined between the mold portion 43 of the inner-surface molding piece 42 and the mold surface 62 of the outer-surface molding piece 58. The outer-surface molding piece 58 has a width (in directions along the x-axis) and a thickness (in directions along the z-axis) that correspond to those of the base element 45 of the inner-surface molding piece 42. In addition, the outer-surface molding piece 58 on front, rear, left, and right sides has outer wall surfaces that define corners and angles which correspond to those defined by outer wall surfaces of the base element 45 on front, rear, left, and right sides.

The first slide piece 41 may be produced as one piece including the inner-surface molding piece 42 and the outer-surface molding piece 58. Or, the inner-surface molding piece 42 and the outer-surface molding piece 58 may be produced as distinct components and coupled together as in the instant embodiment, for the purpose of convenience in terms of machinability of mold surfaces, among others.

The second slide piece 71 shapes the hole P12 provided in the cylindrical boss P11 and a part of the inner side of the cylindrical boss P11 and includes a rod-like main element 75 and a plate-like mold portion 76 on a distal end of the rod-like main element 75. When viewed in a front view, a right edge of the mold portion 76 is on the extension of the main element 75 while a left edge of the mold portion 76 is aligned with an outer wall surface of the mold portion 43 of the inner-surface molding piece 42. The mold portion 76 has an end which is provided with a protrusion 77 used to perforate the hole P12. The main element 75 has a proximal end that is provided with an engagement pawl 78 fitted slidably in the engagement groove 85 in the carrier piece 81.

The second slide piece 71 is assembled such that the main element 75 is fitted in the guide channel 50 in the first slide piece 41. The second slide piece 71 is integrated into the first slide piece 41 such that, in the die clamping state, the mold portion 76 fits into the valley 51 in the first slide piece 41 without forming any clearances and is put in flush with the top side of the inner-surface molding piece 42 and a circumferential surface of the mold portion 43.

The carrier piece 81 represents a block-shaped piece which slidably carries the second slide piece 71 and which guides the second slide piece 71 in such a way to decouple itself from the hole P12. The carrier piece 81 is coupled to the ejector plate 110 through the carrier piece ejector pin 122 and thereby serve as a movable carrier piece that can advances and retracts along the demolding direction of the molded article P1 while being integrated with the ejector plate 110.

The carrier piece 81 has a width (in directions along the x-axis) that corresponds to the distance between the left and right inner wall surfaces 23, 24 of the inner holder 23, and the carrier piece 81 has left and right wall surfaces 83, 84 that extend parallel to the inner wall surfaces 23, 24 of the inner holder 20, respectively. Thus, the carrier piece 81 fits in the inner holder 20 without forming any clearances. The carrier piece 81 has a top side which defines a slope that runs parallel to a perforating direction of the hole P12 when viewed in a front view. The top side is provided with the engagement groove 85 which extends parallel to the top side and in which the engagement pawl 78 provided on the proximal end of the main element 75 of the second slide piece 71 is slidably fitted.

In the foregoing undercut processing mechanism 11, the first slide piece 41 is integrated with the second slide piece 71 and received in the inner holder 20, with one end of the second slide piece 71 being in engagement with the carrier piece 81. They are, in turn, received in the outer holder 30 to represent a single compact unit. The unit is installed to the movable part 101 of the molding die 1 to form the molding die 1.

Next, the operation and effects of the molding die 1 according to the instant embodiment will be described. During the molding phase for the molded article P1, a molding material is injected through the sprue bushing of the fixed die 100 in the die clamping state of the molding die 1 and is hardened to produce the molded article P1 (see FIG. 1). During the molding phase, the top side of the inner holder 20 and a top surface of the slide piece 40 of the undercut processing mechanism 11 are placed in flush with the top surface of the movable die plate 108 so as to come into contact with and shape the article P being molded (or the molding material), with the slide piece 40 also shaping the cylindrical boss P11 and the hole P12.

The molding phase for the molded article P1 is followed by a die opening phase for the molding die 1. During the die opening phase for the molding die 1, the movable die 101 is displaced downwards in its entirety in FIG. 1 along with the molded article P1 which, therefore, remain on the side of the movable die 101. The die opening phase for the molding die 1 is followed by an ejection phase for the molded article P1. During the ejection phase for the molded article P1, the ejector plate 110 moves upwards in FIG. 1.

This movement of the ejector plate 110 in the undercut processing mechanism 11 causes the inner holder 20 and the carrier piece 81 to move upwards (in a positive direction along the y-axis) at the same timings, at the same speeds, and for the same distances. The inner holder 20 is made to protrude from the top surface of the movable die plate 108 to eject the molded article P1 in an upward direction in FIG. 1 in cooperation with the not shown ejector pin. At the same time, the first slide piece 41 is displaced along the guide grooves 37 in the outer holder 30 diagonally upwards to the left in FIG. 1, due to the combination of actions between the left and right inner slopes of the inner holder 20 and the left and right outer wall surfaces 46, 47 of the first slide piece 41 and between the convex stripe 48 on the first slide piece 41 and the guide grooves 37 in engagement therewith. This causes the first slide piece 41 to move away from the cylindrical boss P11 to thereby decouple the first slide piece 41 from the cylindrical boss P11 (see FIG. 3).

On the other hand, the second slide piece 71 is forced up by the carrier piece 81 and guided along the guide channel 50 and the valley 51 in the first slide piece 41 as well as along the engagement groove 85 in the carrier piece 81, such that the second slide piece 71 undergoes a movement in the demolding direction of the molded article P1 while being displaced diagonally downwards to the right in FIG. 1 at the same time, thereby bringing the protrusion 77 out of engagement with the hole P12 (see FIG. 3).

By the end of the ejection phase for the molding article P1, the slide piece 40 has been decoupled from the undercut portions P11, P12 with the molded article P assuming an ejected position from the movable die plate 108 by the actions of the not shown ejector pin and the inner holder 20 (see FIG. 3). After the molded article P1 is taken out, the die clamping phase for the molding die 1 commences again to mold a next article P1.

At the die clamping phase, the movable part 101 is displaced in its entirety in an upward direction in FIG. 1 while the ejector plate 110 is moved in a downward direction in FIG. 1. This movement of the ejector plate 110 in the undercut processing mechanism 11 causes the inner holder 20 to be pulled into the movable die plate 108 by means of the inner holder ejector pin 121 and also causes the carrier piece 81 to be brought back into a molding position by means of the carrier piece ejector pin 122. In addition, the slide piece 40 is guided along the left and right inner wall surfaces 22, 23 of the inner holder 20, the guide grooves 37 in the outer holder 30, and the engagement groove 85 in the carrier piece 81 and is thereby brought back into a molding position.

As described thus far, the molding die 1 and the undercut processing mechanism 11 according to the instant embodiment are configured such that the slide piece 40 is slidably received in the inner holder 20, while the inner holder 20, together with the carrier piece 81, moves in the demolding direction of the molded article P1 to effect ejection of the molded article P1 as well as releasing of the undercut portions P11, P12. As a result, even a molded article P1 with a first undercut portion P11 which forms a projection extending along a direction that forms a crossing angle to the demolding direction of the molded article and a second undercut portion P12 which is provided in or at the first undercut portion P11 and which defines a releasing direction that is different from that of the first undercut portion P11 can be readily produced.

Such a molded article P1 with the first undercut portion P11 which forms a projection extending along a direction that forms a crossing angle to the demolding direction of the molded article as a cylindrical boss P11 and the second undercut portion P12 which is provided in the cylindrical boss P11 as a hole P12 might be produced by molding a main body of the article and a separate component containing the cylindrical boss P11 perforated with the hole P12 and subsequently joining them together.

If the main body of the article and the separate component containing the cylindrical boss P11 perforated with the hole P12 were molded and subsequently joined together to produce the molded article P1, a cross-section of the molded article P1 at a boundary between the main body of the article and a region of the cylindrical boss P11 would contain a seam mark, such as a joining seam, adhesion seam, or a weld scam, present therebetween. In contrast, the molding die 1 integrated with the undercut processing mechanism 11 can be used to integrally mold the main body of the article and a part including the undercut portions, such that a cross-section of the article at a boundary between the main body of the article and a region of the cylindrical boss P11 contains no seam mark, such as a joining seam, adhesion seam, or a weld seam, present therebetween. The same also applies to articles to be molded according to the rest of the embodiments of the present invention.

Further, the first slide piece 41 in the undercut processing mechanism 11 is integrated with the second slide piece 71 and is received in the inner holder 20, with one end of the second slide piece 71 being in engagement with the carrier piece 81. They are, in turn, received in the outer holder 30 to form a single unit. The unit is installed to the movable die plate 108 and is coupled to the inner holder ejector pin 121 and the carrier piece ejector pin 122 to thereby complete the integration of the molding die 1. Such an undercut processing mechanism 11 can be handled as a single unit, and therefore facilitates its integration into the molding die 1 and even promotes its retrofitting to a pre-existing molding die. Furthermore, the undercut processing mechanism 11 is quite compact as is evident from FIGS. 1 and 2.

Also, while the molding die 1 according to the instant embodiment uses the not shown ejector pin to eject the molded article P1, it is even conceivable to do away therewith to eject the molded article with the inner holder 20 alone, if conditions such as weights, the positions of undercut portions formed in or at the molded article, etc. allow. By omitting such an ejector pin which is dedicated to ejection of the molded article, a further reduction in size and cost can be achieved for the molding die 1.

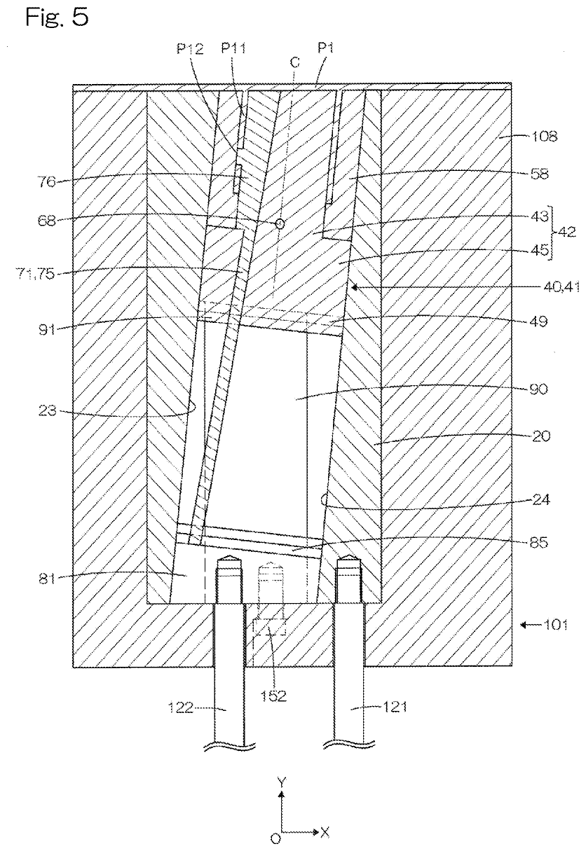

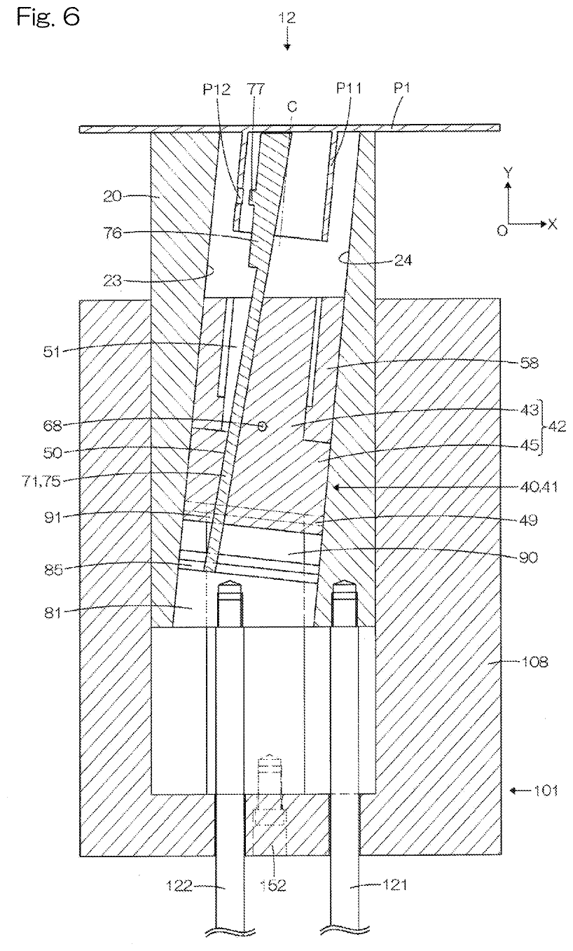

FIGS. 5 and 6 are diagrams that illustrate the configuration of the undercut processing mechanism 12, according to the second embodiment of the present invention. FIG. 5 shows a front cross sectional view of the same during a molding phase for a molded article P1, while FIG. 6 shows a front cross sectional view of the same during an ejection phase for the molded article P1. Among the features of the undercut processing mechanism 12 according to the second embodiment of the present invention, those equivalent to features of the undercut processing mechanism 11 according to the first embodiment shown in FIGS. 1 to 4 are indicated with the same reference symbols and will not be described for simplicity.

The undercut processing mechanism 12 according to the second embodiment is integrated into and used with a molding die 1 which is analogous to the molding die 1 for the undercut processing mechanism 11 according to the first embodiment. The undercut processing mechanism 12 has the same general configuration as that of the undercut processing mechanism 11 according to the first embodiment, with a similar article P1 to be molded and undercut portions P11, P12 to be shaped. The following discussion focuses on what differs from the undercut processing mechanism 11.

The structural difference of the undercut processing mechanism 12 according to the second embodiment from the undercut processing mechanism 11 according to the first embodiment consists in a guiding section configured to guide the first slide piece 41 along a direction perpendicular to the central axis C of the undercut portion P11. In the undercut processing mechanism 11 according to the first embodiment, the guide grooves 37 are provided in the outer holder 30 to guide the first slide piece 41 along a direction perpendicular to the central axis C of the undercut portion P11. In contrast, the undercut processing mechanism 12 according to the second embodiment does not include an outer holder 30, but is provided with a guide piece 90 having a distal end which is provided with a guide groove 91.

The guide piece 90 represents an elongated block-shaped component which is positioned below the first slide piece 41 on a rear side of the carrier piece 81 and which is fixed to the movable die plate 108 with a fastener 152. The guide piece 90 has a distal end provided with the guide groove 91 in which an engagement pawl 49 on the first slide piece 41 is slidably fitted. The guide groove 91 is a substitute for the guide grooves 37 in the outer holder 30 according to the first embodiment and is provided so as to extend perpendicular to the central axis C of the cylindrical boss P11 when viewed in a front view, just like the guide grooves 37. The engagement pawl 49 on the first slide piece 41 plays a role corresponding to that of the convex stripe 48 on the first slide piece 41 according to the first embodiment.

In the undercut processing mechanism 12 according to the instant embodiment, the thicknesses of the carrier piece 81 and the guide piece 90 are selected such that the combined thicknesses correspond to the depth of the internal space of the inner holder 20 so that the carrier piece 81 and the guide piece 90 can be received in the inner holder 20. In this way, a more compact design for the undercut processing mechanism 12 can be achieved. Since the first slide piece 41 does not have convex stripe 48 protruding on a front side and on a rear side of the undercut processing mechanism 12, there is no need to provide openings 26 in the inner holder 20 on a front side and a rear side thereof.

The operation of the foregoing undercut processing mechanism 12 according to the second embodiment is basically the same as that of the undercut processing mechanism 11 according to the first embodiment. Since the undercut processing mechanism 12 according to the second embodiment does not require the outer holder 30, a more compact design is promoted just like or better than by the undercut processing mechanism 11 according to the first embodiment. It should be noted that, as in the first embodiment, an outer holder may be provided in the undercut processing mechanism 12 according to the second embodiment with a view to preventing the wear, damage, etc. of the movable die plate 108. The outer holder in this case does not need guide grooves to guide the movement of the first slide piece 41.

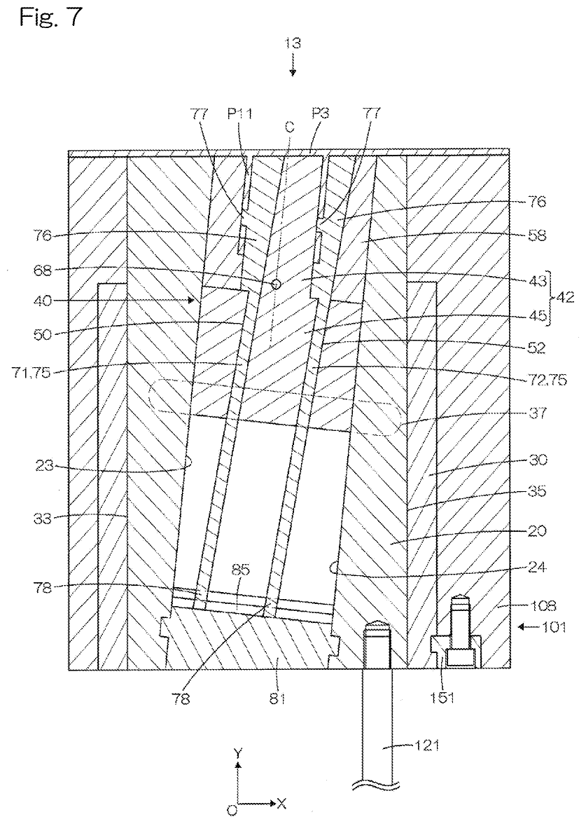

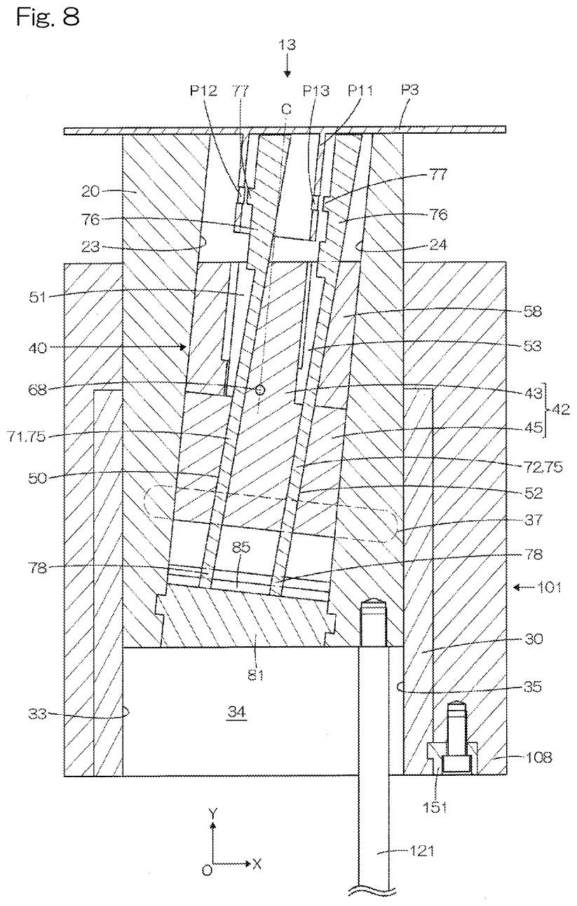

FIGS. 7 and 8 are diagrams that illustrate the configuration of the undercut processing mechanism 13, according to the third embodiment of the present invention. FIG. 7 shows a front cross sectional view of the same during a molding phase for a molded article P3, while FIG. 8 shows a front cross sectional view of the same during an ejection phase for the molded article P3. Among the features of the undercut processing mechanism 13 according to the third embodiment of the present invention, those equivalent to features in the undercut processing mechanism 11 according to the first embodiment shown in FIGS. 1 to 4 are indicated with the same reference symbols and will not be described for simplicity.

The undercut processing mechanism 13 according to the third embodiment is integrated into and used with a molding die 1 which is analogous to the molding die 1 for the undercut processing mechanism 11 according to the first embodiment. The undercut processing mechanism 13 has the same general configuration as that of the undercut processing mechanism 11 according to the first embodiment, in that the inner holder 20, the outer holder 30, the slide piece 40, and the carrier piece 81 are included and can be configured as a single unit just like the undercut processing mechanism 11 according to the first embodiment. As thus described, the undercut processing mechanism 13 according to the third embodiment is analogous to the undercut processing mechanism 11 according to the first embodiment for the large part, but partially differs in structure from the undercut processing mechanism 11 according to the first embodiment because the molded article P3 has an undercut portion configuration different from that of the molded article P1.

The molded article P1 presented according to the first and second embodiments includes a first undercut portion P11 which forms a projection extending along a direction that forms a crossing angle to the demolding direction of the molded article P1 as the cylindrical boss P11 and a second undercut portion P12 in the form of the hole P12 provided on a given location of a shank of the cylindrical boss P11. In contrast, the molded article P3 according to the instant embodiment includes a first undercut portion P11 which forms a projection extending along a direction that forms a crossing angle to a demolding direction of the molded article P3 as a cylindrical boss P11 and second undercut portions in the form of two holes P12, P13 present on mutually opposite locations on a shank of the cylindrical boss P11.

Generally speaking, the undercut processing mechanism 13 integrated into the molding die for molding the article P3 is based on the structure of the undercut processing mechanism 11 that is further combined with another second slide piece 72 which is configured to perforate the hole P13. Another second slide piece 72 is also configured to shape a part of an outer side of the cylindrical boss P11. Another second slide piece 72 has a geometry and a structure that are analogous to those of the second slide piece 71 and is positioned to extend parallel to the second slide piece 71. The second slide piece 71 is positioned inside the cylindrical boss P11 so as to bring the protrusion 77 out of engagement with the hole P12 by being moved towards the central axis C of the cylindrical boss P11. On the other hand, another second slide piece 72 is positioned outside the cylindrical boss P11 so as to bring a protrusion 77 out of engagement with the hole 13 by being moved away from the cylindrical boss P11. In the instant embodiment, the two second slide pieces 71, 72 represent mold pieces configured to shape two second undercut portions. Moreover, the first slide piece 41 and the second slide pieces 71, 72 in the instant embodiment correspond, respectively, to a slider and slide members of a sliding mechanism according to the present invention.

A guide that guides a movement of another second slider piece 72 will be discussed. The first slide piece 41 includes a guide channel 52 provided in the base element 45 for guiding another second slide piece 72, in addition to the guide channel 50 for guiding the second slide piece 71. The guide channel 52 is provided so as to extend parallel to the guide channel 50. The outer-surface molding piece 58 is additionally provided with a valley 53 for receiving a mold portion 76 of another second slide piece 72. The valley 53 plays a role analogous to that of the valley 51 which receives the second slide piece 71. In addition, another second slide piece 72 has an engagement pawl 78 in slidable engagement with the engagement groove 85 in the carrier piece 81.

Just like the second slide piece 71, another second slide piece 72 is assembled such that a main element 75 of another second slide piece 72 is fitted in the guide channel 52 in the first slide piece 41. Another second slide piece 72 is integrated into the first slide piece 41 such that, in a die clamping state, the mold portion 76 of another second slide piece 72 fits into the valley 53 provided in the outer-surface molding piece 58 of the first slide piece 41 without forming any clearances and a top surface and a side surface of another second slide piece 72 are put in flush with a top side and an outer circumferential surface of the outer-surface molding piece 58. During the demolding phase for the molded article P3, another second slide piece 72 moves together with the second slide piece 71 at the same timings and for the same distances to thereby bring the protrusion 77 on another second slide piece 72 out of engagement with the hole P13.

While, in case of the undercut processing mechanisms 11, 12, the carrier piece 81 is coupled to the ejector plate 110 through the carrier piece ejector pin 122, the carrier piece 81 in the instant embodiment is fixed to the inner holder 20. In the instant embodiment, a convex stripe is provided on the carrier piece 81 and a concave groove is provided in the inner holder 20, such the convex stripe on the carrier piece 81 is fitted into the concave groove provided in the inner holder 20 to fix the carrier piece 81 to the inner holder 20. However, this is only one of non-limiting examples of how the carrier piece 81 can be fixed to the inner holder 20.

It is described with respect to the first and second embodiments that the carrier piece 81 needs to move together with the inner holder 20 at the same timings, at the same speeds, and for the same distances. A similar movement can also be achieved by a carrier piece 81 which is fixed to the inner holder 20, as represented in the instant embodiment. The carrier piece 81 in the undercut processing mechanism 13 may alternatively be coupled to the ejector plate 110 through a carrier piece ejector pin 122, just like those in the undercut processing mechanisms 11, 12. Conversely, the carrier pieces 81 in the undercut processing mechanisms 11, 12 may alternatively be fixed to the inner holder 81. The same applies to undercut processing mechanisms that will be later discussed.

Just like the undercut processing mechanism 11 according to the first embodiment, the foregoing undercut processing mechanism 13 is configured such that, during the demolding phase for the molded article P3, the inner holder 20 and the carrier piece 81 move in the demolding direction of the molded article P3 so as to cause the slide piece 40 to move in such a direction that decouple the slide piece 40 from the undercut portions P11. P12, P13.

Even in case of a molded article P3 with a first undercut portion in the form of the cylindrical boss P11 and second undercut portions in the form of the two holes P12, P13, the undercut processing mechanism 13 as described thus far allows for releasing of the undercut portions. With a molding die integrated with the undercut processing mechanism 13, even a molded article having such a complex structure can be readily produced. Further, the undercut processing mechanism 13 is compact and can be provided as a single unit, thereby also facilitating its retrofitting to a pre-existing die.

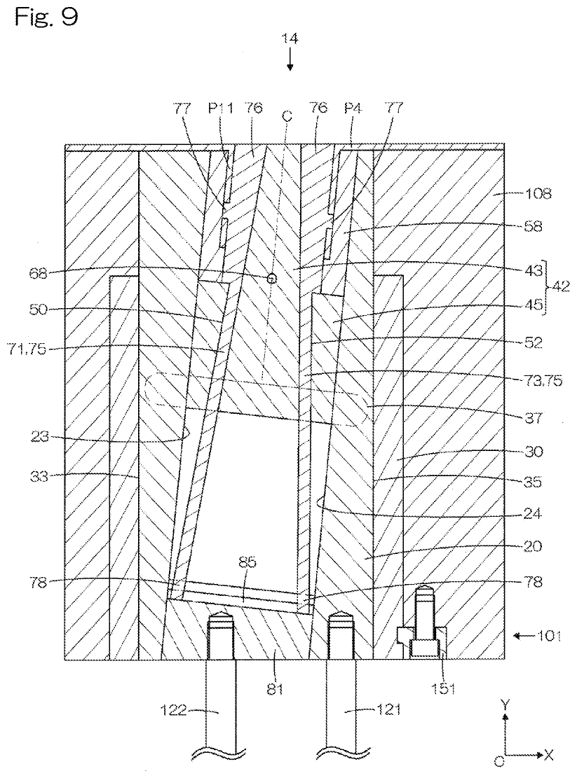

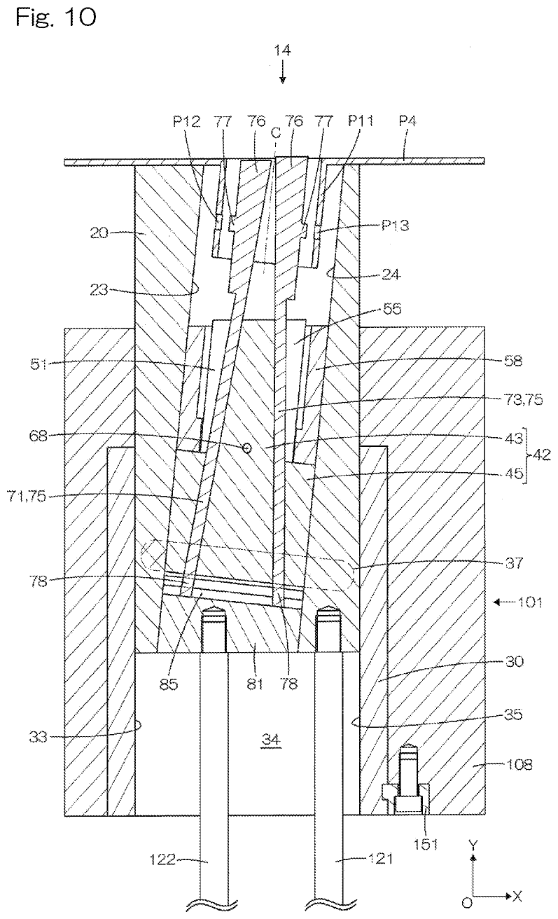

FIGS. 9 and 10 are diagrams that illustrate the configuration of the undercut processing mechanism 14, according to the fourth embodiment of the present invention. FIG. 9 shows a front cross sectional view during a molding phase for a molded article P4, while FIG. 10 shows a front cross sectional view during an ejection phase for the molded article P4. Among the features of the undercut processing mechanism 14 according to the fourth embodiment of the present invention, those equivalent to features of the undercut processing mechanism 11 according to the first embodiment shown in FIGS. 1 to 4 and features of the undercut processing mechanism 13 according to the third embodiment shown in FIGS. 7 and 8 are indicated with the same reference symbols and will not be described for simplicity.

Just like the molded article P3, the molded article P4 according to the fourth embodiment includes an undercut portion P11 which forms a projection extending along a direction that forms a crossing angle to the demolding direction of the molded article P3 as a cylindrical boss P11 and second undercut portions in the form of two holes P12, P13 present on mutually opposite locations on a shank of the cylindrical boss P11. While the shapes and positions of the cylindrical boss P11 and the holes P12, P13 in the molded article P4 are similar to those in the molded article P3, the molded article P4 differs from the molded article P3 in that the cylindrical boss P11 of the molded article P4 has a ceiling side which is open.

Just like the undercut processing mechanism 13, the undercut processing mechanism 14 is integrated into a molding die 1 that molds an article P4 having undercut portions P11, P12, P13. The undercut processing mechanism 14 has the same general configuration as that of the undercut processing mechanism 13. However, another second slide piece 73 in the former differs from the counterpart in the latter in how they move. Another second slide piece 73 is configured to mold a part of an inner side of the cylindrical boss P11 in addition to being configured to perforate the hole 13.

Another second slide piece 72 In the undercut processing mechanism 13 according to the third embodiment is positioned outside the cylindrical boss P11 so as to bring the protrusion 77 out of engagement with the hole 13 by being moved away from the cylindrical boss P11. In contrast, the second slide piece 71 and another second slide piece 73 in the undercut processing mechanism 14 according to the fourth embodiment are both positioned inside the cylindrical boss P11 so as to bring the protrusions 77 out of engagement with the respective holes P12, P13 by being moved towards the central axis C of the cylindrical boss P11. In the instant embodiment, the two second slide pieces 71, 73 represent mold pieces configured to shape two second undercut portions. Moreover, the first slide piece 41 and the second slide pieces 71, 73 in the instant embodiment correspond, respectively, to a slider and slide members of a sliding mechanism according to the present invention.

The configuration of the undercut processing mechanism 14 according to the fourth embodiment will be described below by focusing on what differs from the undercut processing mechanism 13 according to the third embodiment.

Another second slide piece 73 configured to mold the hole P13 in the undercut processing mechanism 14 has a shape and a structure that are analogous to those of the second slide piece 71 configured to shape the hole P12, and is positioned symmetrically to the second slide piece 71 with respect to the central axis C of the cylindrical boss P11.

A guide that guides a movement of another second slider piece 73 will be discussed. The inner-surface molding piece 42 includes a guide channel 52 provided in the base element 45 for guiding another second slide channel 73, in addition to the guide channel 50 for guiding the second slide piece 71. The guide channel 52 defines a slanting direction which runs in the opposite orientation to that of a slanting direction of the guide channel 50. The inner-surface molding piece 42 is provided with a valley 55 for receiving a mold portion 76 of another second slide piece 73, in addition to a valley 51 which receives the mold portion 76 of the second slide piece 71. The valleys 51, 55 are set back towards each other. In addition, another second slide piece 73 has an engagement pawl 78 in slidable engagement with the engagement groove 85 in the carrier piece 81.

Just like the second slide piece 71, another second slide piece 73 is assembled such that a main element 75 of another second slide piece 73 is fitted in the guide channel 52 in the first slide piece 41. Another second slide piece 73 is integrated into the first slide piece 41 such that, in a die clamping state, the mold portion 76 fits into the valley 55 in first slide piece 41 without forming any clearances and a top surface and a side surface of another second slide piece 73 are put in flush with a top side and an outer circumferential surface of the inner-surface molding piece 42. During the demolding phase for the molded article P4, another second slide piece 73 moves together with the second slide piece 71 at the same timings to thereby bring the protrusion 77 on another second slide piece 73 out of engagement with the hole P13.

The slanting angles of the guide channel 52 and the valley 55 along which a movement of another second slide piece 73 is guided force another second slide piece 73 to move up along the engagement groove 85 in the carrier piece 81. This causes the top surface of the mold portion 76 of another second slide piece 73 to protrude upwards relative to the top side of the cylindrical boss P11 during the process of bringing the protrusion 77 out of engagement with the hole P13. Still, because the ceiling side of the cylindrical boss P11 of the molded article P4 is open, the protrusion 77 can be successfully brought out of engagement with the hole P13 without any trouble.

In order to successfully bring the protrusions 77 provided on the second slide pieces 71, 72, 73 out of engagement with the holes P12, P13 in the undercut processing mechanisms 11, 12, 13, 14 without any trouble, the engagement groove 85 in the carrier piece 81 should have a slanting angle matching with perforating angles of the holes P12, P13. The engagement grooves 85 in the carrier pieces 81 in the undercut processing mechanisms 13, 14 according to the third and fourth embodiments represent slanting grooves that extend linearly downwards to the right when viewed in a front view. This is in order to have them match with the perforating angles of the holes P12, P13 provided in the cylindrical boss P11.

If an article similar to that of the instant embodiment but with different perforating angles of the holes P12, P13 is to be molded, the carrier piece 81 can be provided with engagement grooves 85, each for a respective one of the holes P12, P13. For instance, if the hole P12 extends upwards to the left and the hole P13 extends upwards to the right, the engagement grooves 85 can be arranged in a V-shaped configuration when viewed in a front view.

If there is a risk that the second slide pieces 71, 73 may keep moving and collide with each other after having decoupled from the holes P12, P13, respectively, the carrier piece 81 can be provided with another guide groove for preventing a collision between the second slide pieces 71, 73, subsequently to the engagement groove(s) 85 that is/are responsible for decoupling the second slide pieces 71, 73 from the holes P12, P13. Whether for preventing a collision or not, such a groove may include a straight line, a curved line, or a combination of a straight line and a curved line, and can even comprise more than one such groove.

Another way to eliminate the risk that the second slide pieces 71, 73 may keep moving and collide with each other after having decoupled from the holes P12, P13, respectively, is to retain the second slide pieces 72, 73 in decoupled positions after having decoupled from the holes P12, P13, respectively, for prevention of a collision therebetween. This feature will be covered in the discussion of the undercut processing mechanism 17 according to the seventh embodiment.

Just like the undercut processing mechanism 11 according to the first embodiment, the foregoing undercut processing mechanism 14 is configured such that, during the demolding phase for the molded article P4, the inner holder 20 and the carrier piece 81 move in the demolding direction of the molded article P4 so as to cause the slide piece 40 to move in such a direction that decouples itself from the undercut portions P11, P12, P13.

Even in case of a molded article P4 with a first undercut portion in the form of the cylindrical boss P11 and second undercut portions in the form of the two holes P12, P13, the undercut processing mechanism 14 as described thus far allows for releasing of the undercut portions. With a molding die integrated with the undercut processing mechanism 14, even a molded article having such a complex structure can be readily produced. Further, the undercut processing mechanism 14 is compact and can be provided as a single unit, thereby also facilitating its retrofitting to a pre-existing die.

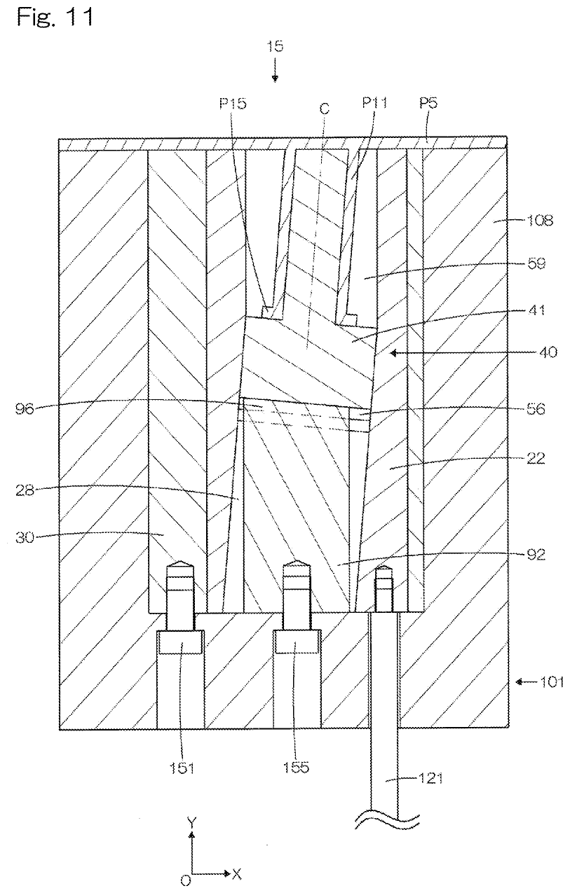

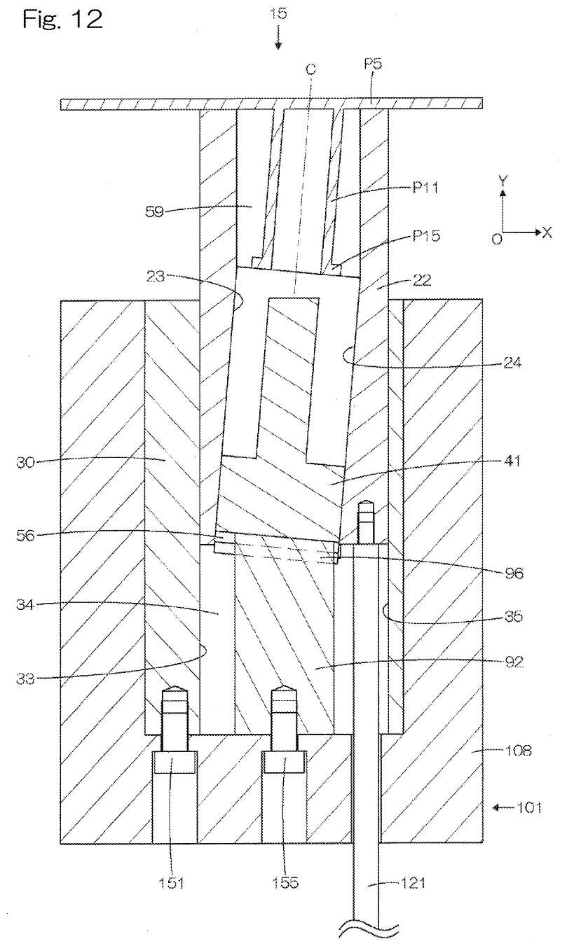

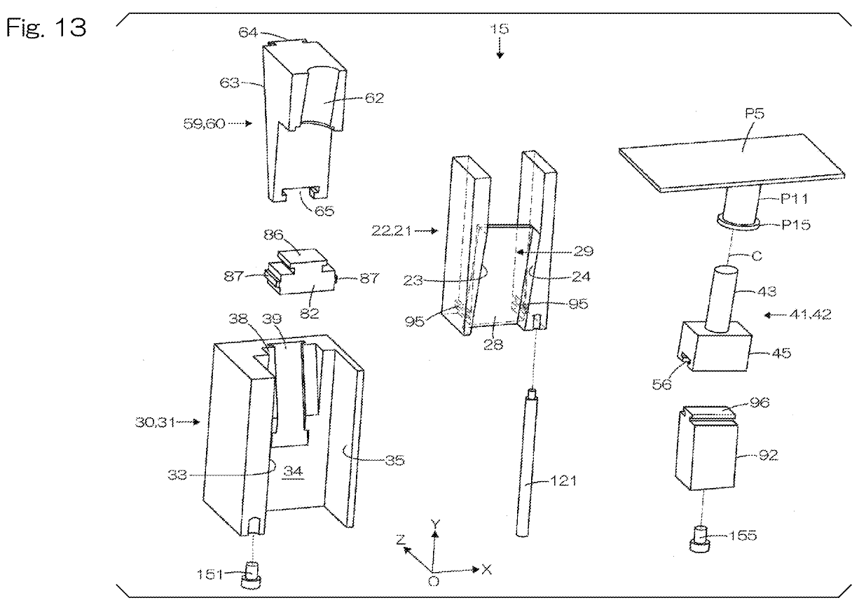

FIGS. 11 and 12 are diagrams that illustrate the configuration of the undercut processing mechanism 15, according to the fifth embodiment of the present invention. FIG. 11 shows a front cross sectional view of the same during a molding phase for a molded article P5, while FIG. 12 shows a front cross sectional view of the same during an ejection phase for the molded article P5. FIG. 13 shows an exploded view of components of the undercut processing mechanism 15, according to the fifth embodiment of the present invention. FIG. 13 depicts only one of a pair of constituent components for each of the inner holder 22, the outer holder 30, the outer-surface molding piece 59, and the carrier piece 82, respectively.

Just like the undercut processing mechanism 11 according to the first embodiment, the undercut processing mechanism 15 according to the fifth embodiment of the present invention is installed to and used with a molding die 1. Among the features of the undercut processing mechanism 15 according to the fifth embodiment of the present invention, those equivalent to features in the undercut processing mechanism 11 according to the first embodiment shown in FIGS. 1 to 4 are indicated with the same reference symbols and will not be described for simplicity.

The molded article P5 according to the fifth embodiment includes a first undercut portion P11 which forms a projection extending along a direction that forms a crossing angle to a demolding direction of the molded article P5 as the cylindrical boss, just like that of the molded article P1, but also includes a second undercut portion in the form of a flange P15 on a distal end of the cylindrical boss P11. The flange P15 is provided on an entire circumference of the cylindrical boss P11 so as to project outwards and perpendicularly to the central axis C of the cylindrical boss P11. The cylindrical boss P11 is equivalent to the cylindrical boss P11 of the molded article P1.

The undercut processing mechanism 15 integrated into the molding die 1 that molds the article P5 includes an inner holder 22 which slidably receives a slide piece 40 and a carrier piece 82, an outer holder 30 which slidably receives a part or entirety of the inner holder 22, the slide piece 40 which is in slidable engagement with the inner holder 22 and the outer holder 30 and which shapes the undercut portions P11, P15, and the carrier piece 82 which is in engagement with and slidably carries an outer-surface molding piece 59.

The slide piece 40, the carrier piece 82, the inner holder 22, and the outer holder 30 in the undercut processing mechanism 15 according to the instant embodiment correspond, respectively, to a slider, an interlock member, an inner holder, and an outer holder of a sliding mechanism according to the present invention. Moreover, an inner-surface molding piece 42 and the outer-surface molding piece 59 as components of the slide piece 40 correspond to slide members of a sliding mechanism according to the present invention.

Further, convex stripe 86 provided on the carrier piece 82, inner wall surfaces 23, 24 of the inner holder 20, and guide grooves 39 and inner wall surfaces 33, 35 provided in and on the outer holder 30 correspond, respectively, to a guiding section provided at an interlock member, a guiding section provided at an inner holder, a guiding section provided at an outer holder and configured to guide a slider along a predetermined direction, and a guiding section provided at the inner holder and configured to guide the inner holder along a first direction in a sliding mechanism according to the present invention. Furthermore, a demolding direction of the molded article P5 and releasing directions of the undercut portions in the undercut processing mechanism 15 according to the instant embodiment correspond, respectively, to a first direction and a predetermined direction in a sliding mechanism according to the present invention.

The undercut processing mechanism 15 has a general configuration which is similar to that of the undercut processing mechanism 11, including the fact that the inner holder 22 and the carrier piece 82 are moved in the demolding direction of the molded article P5 for decoupling of the undercut portions P11, P15. On the other hand, what differs from the undercut processing mechanism 11 is changes made in the shapes and the structures of the components of the undercut processing mechanism 15 in order to adapt to the shape and the structure of the second undercut portion and others.

The outer-surface molding piece 59 is configured to shape an outer side of the cylindrical boss P11 as well as the flange section P15 and is formed of a pair of split mold piece 60. The pair of mold pieces 60 are split pieces which have identical shapes and structures. The mold pieces 60 have inner sides with mold surfaces 62 for shaping an outer side of the cylindrical boss P11, including flange section halves P15. The pair of mold pieces 60 are mated with each other such that the mutual mold surfaces 62 oppose each other and serve to shape the entire outer side of the cylindrical boss P11 including the flange section P15.

The outer-surface molding piece 59 serves as a first slide piece in that it shapes a first undercut portion in the form of the cylindrical boss P11 and is also serves as a second slide piece in that it shapes a second undercut portion in the form of the flange P15. Thus, the outer-surface molding piece 59 is regarded as a first slide piece concurrently serving the function of a second slide piece.

Each of the mold pieces 60 has an outer profile that is generally shaped like a triangular prism with one of the faces that is on the side opposite to a mold surface 62 defining a slope 63. The pair of mold pieces 60 are positioned such that the slopes 63 are symmetrically arranged across the cylindrical boss P11. Each of the slopes 63 is provided with a convex stripe 64 extending parallel to that slope 63. The convex stripe 64 are in engagement with the guide grooves 39 provided in the outer holder 30. In addition, the mold pieces 60 have bottoms provided with guide grooves 65 which are in engagement with the convex stripe 86 provided on the carrier piece 82. The convex stripe 64 and the guide grooves 65 are guided along each other so as to decouple the mold pieces 60 from the undercut portions P11, P15.

Just like the inner holder 20, the inner holder 22 of the instant embodiment is formed of a pair of split holder 21 that are mated with each other to be formed in a square tube for use. Each split holder 21 includes a divider plate 28 that is internally incorporated therein, such that the inner holder 22 comprises a housing volume 29 having front and rear sides defined by a pair of the divider plates 28 and left and right sides defined by the inner wall surfaces 23, 24 for slidably receiving the first slide piece 41. The pair of divider plates 28 provide slide surfaces with which a base element 45 of the first slide piece 41 is in slidable contact. Also arranged in the housing volume 29 is a guide piece 92. Further, the inner holder 22 includes guide grooves 95 in which the carrier piece 82 is slidably fitted, outside the housing volume 29 in the left and right wall surfaces at a lower part of the inner holder 22. The guide grooves 95 are provided on the front and rear sides of the inner holder 22 and each associated with a respective one of a pair of elements of the carrier piece 82.

Just like the outer holder 30 of the first embodiment, the outer holder 30 of the instant embodiment is formed of a pair of split holders 31 that are mated with each other to form a square tube for use. The outer holder 30 includes slopes 38 with which the slopes 63 of the mold pieces 60 are in slidable contact, on an inner wall surface on a front side and an inner wall surface 34 on a rear side of the outer holder 30. The slopes 38 are provided with the guide grooves 39 in which the convex stripe 64 provided on the slopes 63 of the mold pieces 60 are slidably fitted.

The slopes 38 and the guide grooves 39 slant away from the mold surfaces 62 in directions along the z-axis as they extend upwards. Through the engagement of the convex stripe 86 of the carrier piece 82 with the guide grooves 65 and the slidable fitting of the convex stripe 64 in the guide grooves 39, the mold pieces 60 are moved in such a way to decouple themselves from the undercut portions P11, P15.

The carrier piece 82 comprises a pair of carrier piece elements in order to each slidably carry a respective one of the pair of mold pieces 60. The carrier piece elements 82 have top sides provided with the convex stripe 86 in slidable engagement with the guide grooves 65 provided in the bottoms of the mold pieces 60. Also, the carrier piece elements 82 have left and right wall surfaces provided with convex stripes 87 that are slidably fitted in the guide grooves 95 provided in the inner holder 22. The pair of carrier piece elements 82 are each fitted in a respective one of the guide grooves 95 provided on front and rear sides of the inner holder 22, so as to move together with the inner holder 22 along the demolding direction of the molded article P5.

The guide piece 92 is fixed to the movable die plate 108 with a fastening screw 155 and is configured to guide the inner-surface molding piece 42 in such a way to decouple itself from the undercut portion P11. The guide piece 92 has a top side provided with a convex stripe 96 that is slidably fitted in a guide groove 56 provided in a bottom of the inner side mold surface 42. The guide piece 92 and the convex stripe 96 correspond, respectively, to the guide piece 90 and the guide groove 91 in the undercut processing mechanism 12 according to the second embodiment.

In the foregoing undercut processing mechanism 15, the carrier piece elements 82 are fitted in the guide grooves 95 provided on the front and rear sides of the inner holder 22. In addition, the pair of mold pieces 60 are arranged in engagement with the convex stripe 86 on respective ones of the carrier piece elements 82. On the other hand, the inner-surface molding piece 42 in engagement with the guide piece 92 is arranged in the housing volume 29 in the inner holder 22. The inner holder 22 with the mold pieces 60, the carrier piece elements 82, the guide piece 92, and the inner-surface molding piece 42 arranged therein or thereon in certain positions is accommodated in the outer holder 30 such that the convex stripe 64 on the mold pieces 60 are fitted in the guide grooves 39 in the outer holder 30. In summary, the undercut processing mechanism 15 forms a single unit with each piece element housed in the outer holder 30.

Next, the operation and effects of the undercut processing mechanism 15 will be described. In the undercut processing mechanism 15, the inner holder 22 moves upwards (in a positive direction along the y-axis) in response to the displacement of the ejector plate 110. This also results in the molded article P5 being ejected upwards. As the inner holder 22 moves upwards (in a positive direction along the y-axis), the pair of carrier piece elements 82 also move upwards together with the inner holder 22, as they are fitted in the guide grooves 95 in the inner holder 22. Along with this, the pair of mold pieces 60 slidably carried by the carrier piece elements 82 move upwards while they are also guided along the guide grooves 39 such that they move away from each other and from the cylindrical boss P11 in positive and negative directions along the z-axis, respectively. This results in the decoupling of the undercut portion P15.

On the other hand, as the inner holder 22 moves upwards, the inner-surface molding piece 42 is guided along the inner wall surfaces 23, 24 and the convex stripe 96 on the guide piece 92 and is thereby moved in such a way that decouples itself from the first undercut portion P11. While the inner holder 22 is moving upwards, the inner-surface molding piece 42 does not move upwards along with it, because it is in engagement with the guide piece 92 which is fixed to the movable die plate 108. In this way, the upward movement of the inner holder 22 for upward ejection of the molded article P5 causes the inner-surface molding piece 42 to move away from the cylindrical section P11 and to thereby decouples itself from the undercut portion P11.

As such, with the use of the undercut processing mechanism 15, even a molded article P5 with a first undercut portion P11 which forms a projection extending along a direction that forms a crossing angle to the demolding direction of a molded article as the cylindrical boss P11 and a second undercut portion in the form of the flange P15 projecting outwards on a distal end of the cylindrical boss P11 can be readily produced.

Further, just like the undercut processing mechanism 11, the undercut processing mechanism 15 can be handled as a single unit, and therefore facilitates its integration into the molding die 1 and even promotes its retrofitting to a pre-existing molding die. Furthermore, the undercut processing mechanism 15 is quite compact, as is shown in FIGS. 11 to 13.

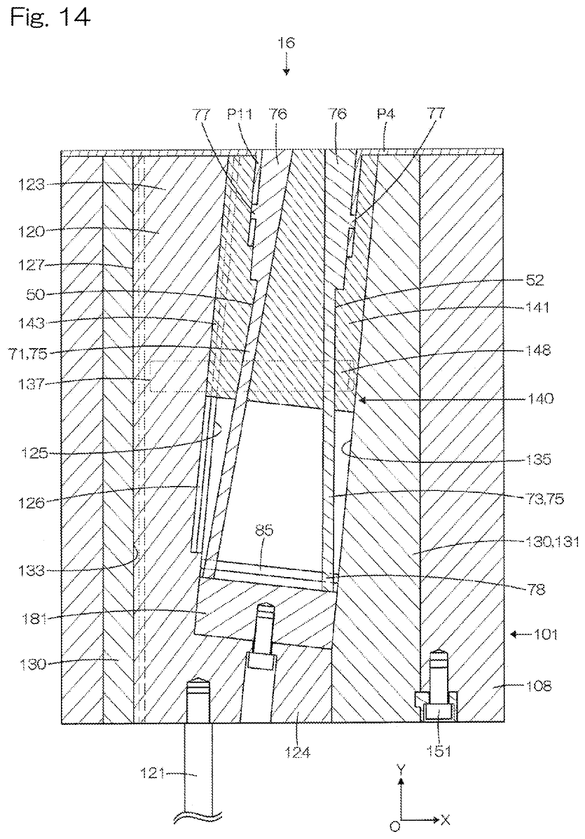

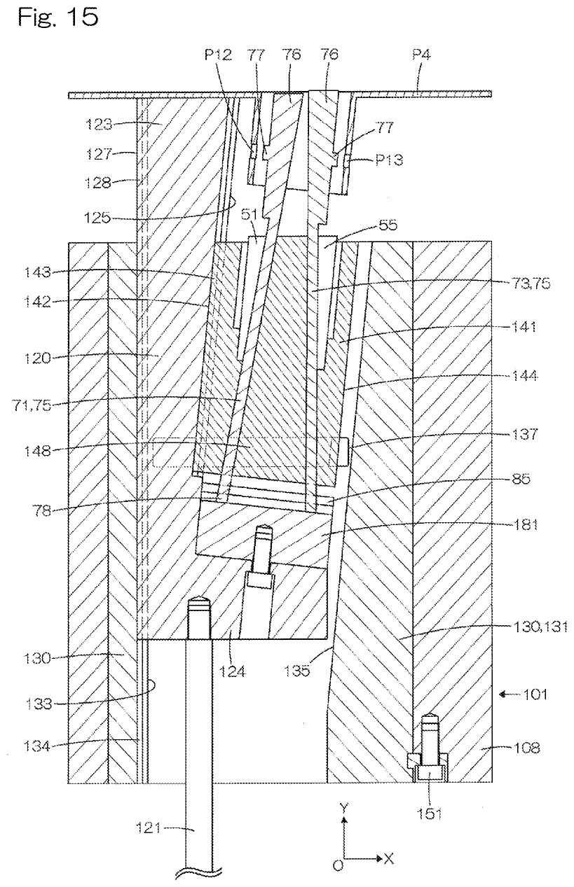

FIGS. 14 and 15 are diagrams that illustrate the configuration of the undercut processing mechanism 16, according to the sixth embodiment of the present invention. FIG. 14 shows a front cross sectional view of the same during a molding phase for a molded article P4, while FIG. 15 shows a front cross sectional view of the same during an ejection phase for the molded article P4. Among the features of the undercut processing mechanism 16 according to the sixth embodiment of the present invention, those equivalent to features of the undercut processing mechanism 11 according to the first embodiment shown in FIGS. 1 to 4 and features of the undercut processing mechanism 14 according to the fourth embodiment shown in FIGS. 9 and 10 are indicated with the same reference symbols and will not be described for simplicity.

Just as the undercut processing mechanisms 11, 14, the undercut processing mechanism 16 is integrated into a molding die 1 to mold an article P4 having undercut portions P11, P12, P13. An article P4 similar to the molded article P4 of the fourth embodiment is molded with the aid of the undercut processing mechanism 16. The undercut processing mechanism 16 has a general configuration which is similar to that of the undercut processing mechanism 14, in that an inner holder 120, an outer holder 130, a slide piece 140, and a carrier piece 181 are included. Yet, the inner holder 120, the outer holder 130, a first slide piece 141, and the carrier piece 181 differ in shape and structure from the inner holder 20, the outer holder 30, the first slide piece 41, and the carrier piece 81.

The slide piece 140, the carrier piece 181, the inner holder 120, and the outer holder 130 as components of the undercut processing mechanism 16 according to the instant embodiment correspond, respectively, to a slider, an interlock member, an inner holder, and an outer holder of a sliding mechanism according to the present invention. Further, the first slide piece 141 and second slide pieces 71, 73 as components of the slide piece 140 correspond to slide members of a sliding mechanism according to the present invention.

The inner holder 120 corresponds to the inner holder 20 and is similar to the inner holder 20 in that the inner holder 120 receives the first slide piece 141 in a certain position during a die clamping phase for the molding die 1 and moves up so as to eject the molded article P4 during the demolding phase for the same and in that the inner holder 120 includes a guide configured to guide the first slide piece 141 in such a way that decouple the first slide piece 141 from the cylindrical boss P11.

The inner holder 120 has a generally L-shaped configuration that includes a left element and a bottom element and does not include a front element, a rear element, or a right element when viewed in a front view. A portion of the inner holder 120 which corresponds to said left element of the inner holder 120 and a portion of the inner holder 120 which corresponds to said lower element of the inner holder 120 are denoted as a left portion 123 and a lower portion 124 of the inner holder 120, respectively.

The left portion 123 has a right wall surface 125 which is equivalent to a left inner wall surface 23 of the inner holder 20 in that it provides a slope with which the first slide piece 141 is in slidable contact. The right wall surface 125 is provided with a concave groove 126 in which a convex stripe 143 provided on the first slide piece 141 is fitted. The concave groove 126 is provided such that, during a die clamping phase and a die opening phase for the molding die, an entire length of the convex stripe 143 provided on the first slide piece 141 fits in the concave groove 126. Nevertheless, the concave groove 126 in the inner holder 120 and the convex stripe 143 on the first slide piece 141 may be provided such that the latter and the former engage with each other in portions.

The left portion 123 has a left wall surface 127 that provides a slide surface with which a left inner wall surface 133 of the outer holder 130 is in slidable contact. The left wall surface 127 is provided with a convex stripe 128 that is fitted in a concave groove 134 provided in the left inner wall surface 133 of the outer holder 130.

The lower portion 124 serves as a mount seat for the carrier piece 181 and is formed as one piece with the left portion 123. In the instant embodiment, the top surface of the lower portion 124 provides a slope extending downwards to the right such that an engagement groove provided on a top side of the carrier piece 181 mounted thereon extends parallel to perforating directions of the holes P12, P13.

The outer holder 130 corresponds to the outer holder 30 and is similar to the outer holder 30 in that the outer holder 130 receives the inner holder 120, the slide piece 140, and the carrier piece 181 during the die clamping phase for the molding die and in that the outer holder 130 guides the inner holder 120 in the demolding direction of the molded article P4 and further guides the first slide piece 141 in such a way to decouple itself from the cylindrical boss P11 during the demolding phase for the molded article P4.

Just like the outer holder 30, the outer holder 130 is formed of a pair of U-shaped half-split holders 131 mated with each other to define a housing volume for receiving the inner holder 120, the slide piece 140, and the carrier piece 181 during the die clamping phase for the molding die. The outer holder 130 has the left inner wall surface 133 that serves as a guide that is in slidable contact with the left inner wall surface 127 of the inner holder 120 to guide the inner holder 120 along the demolding direction for the molded article P4. Further, the left inner wall surface 133 is provided with the concave groove 134 in which the convex stripe 128 on the inner holder 120 is fitted.

The outer holder 130 has a right inner wall surface 135 that provides a slope which extends parallel to a right side surface 144 of the first slide piece 141. Thus, the left and right inner wall surfaces 133, 135 of the outer holder 130 are not parallel. During the die clamping phase for the molding die 1, the outer holder 130 accommodates the first slide piece 141 such that the right side surface 144 of the first slide piece 141 is in contact with the right inner wall surface 135 of the outer holder 130 (see FIG. 14).

Just like the guide grooves 37 in the holder 30, an inner wall surface on a front side and an inner wall surface on a rear side of the outer holder 130 are provided with guide grooves 137 in which convex stripe 148 provided on the first slide piece 141 are slidably fitted. The guide grooves 137 are provided so as to extend in directions along the x-axis and not perpendicularly to the central axis C of the cylindrical boss P11, when viewed in a front view. Alternatively, just like the guide grooves 37 in the outer holder 30, the guide groves 137 may be provided so as to extend perpendicular to the central axis C of the cylindrical boss P11 when viewed in a front view.

The slide piece 140 is similar to the slide piece 40 in that it includes the first slide piece 141 and second slide pieces 71, 73. The slide piece 141 is analogous to the first slide piece 41 of the fourth embodiment in terms of a function and a general configuration. The second slide pieces 71, 73 of the slide piece 140 are equivalent to the second slide pieces 71, 73 of the fourth embodiment.

When viewed in a front view, the first slide piece 141 has a left side surface 142 that is provided with the convex stripe 143 which is slidably fitted in the concave groove 126 provided in the inner holder 120. Further, the first slide piece 141 has a front side wall and a rear side wall that are provided with the convex stripe 148 that are slidably fitted in the guide grooves 137 in the outer holder 130. The first slide piece 141 is formed as one piece that includes the inner-surface molding piece 42 and the outer-surface molding piece 58. Alternatively, just like the slide piece 40, the inner-surface molding piece 42 and the outer-surface molding piece 58 may be provided as distinct components.

The carrier piece 181 is similar to the carrier piece 81 of the fourth embodiment in terms of a function and an operation in addition to an engagement groove 85 formed on a top side thereof and others in general, except that the carrier piece 181 now has a cuboidal shape and is fixed to the inner holder 120. While the lower portion 124 of the inner holder 120 serves as the mount seat to which the carrier piece 181 is fixedly mounted in the undercut processing mechanism 16 according to the instant embodiment, the inner holder 120 and the carrier piece 181 may be detached and have different ejector pins attached thereto as in the undercut processing mechanism 14 according to the fourth embodiment.

In the foregoing undercut processing mechanism 16, the convex stripe 143 provided on the first slide piece 141 is fitted in the concave groove 126 in the inner holder 120. The second slide pieces 71, 73 are integrated into the first slide piece 141 such that engagement pawls 78 thereof are fitted in the engagement groove 85 in the carrier piece 181. Further, the convex stripe 128 provided on the inner holder 120 is fitted in the concave groove 134 in the outer holder 130. After the undercut processing mechanism 16 has thus been assembled into a single unit, the outer holder 130 is fixed to the movable die plate 108.

During the demolding phase for the molded article P4, the molded article P4 is ejected upwards (in a positive direction along the y-axis) by means of an ejector pin 121 to which the inner holder 120 is coupled, as shown in FIG. 15. This causes the inner holder 120 to move up by sliding the left wall surface 127 on the left inner wall surface 133 of the outer holder 130 for the upward ejection of the molded article P4. Simultaneously, as the inner holder 120 is moving up, the first slide piece 141 is guided along the right wall surface 125 of the inner holder 120 with which it is in slidable contact and the guide grooves 137 in the outer holder 130 in which the convex stripe 148 are slidably fitted, so as to move in such a way that decouples itself from the first undercut portion P11.

On the other hand, as the carrier piece 181 moves up along with the upward movement of the inner holder 120, the second slide pieces 71, 73 are guided along guide channels 50, 52 in the first slide piece 141 and the engagement groove 85 in the carrier piece 181, so as to move in such a way to bring protrusions 77 on the left and right, second slide pieces 71, 73 out of engagement with the holes P12, P13, respectively. The movements of the second slide pieces 71, 73 will not be described in detail, because they are equivalent to those in the undercut processing mechanism 14 according to the fourth embodiment.

Unlike the undercut processing mechanisms according to the other embodiments, the undercut processing mechanism 16 according to the sixth embodiment is configured such that only one of opposite side surfaces of the first slide piece 141 is in engagement with the inner holder through mutual, slidable fitting of the convex stripe 143 and the concave groove 126 that are provided in or on respective slide surfaces thereof. Although only a single side surface is used for engagement purposes, it still achieves secure engagement between and stable movements of the first slide piece 141 and the inner holder 120. The same is true for the engagement relationship between the inner holder 120 and the outer holder 130.

The inner holder 120 in the undercut processing mechanism 16 according to the sixth embodiment is not structured to receive an entirety of the slide piece 140, but is structured to cooperate with the outer holder 130 to receive the slide piece 140 in a certain position during the die clamping phase. Thus, the inner holder 120 and the outer holder 130 in the undercut processing mechanism 16 according to the sixth embodiment are each considered to partially receive the slide piece 140.

When viewed in a front view, the inner holder 120 in the undercut processing mechanism 16 according to the sixth embodiment is composed of a left element and a bottom element. Alternatively, the inner holder 120 may have a mirrored L-shaped configuration that includes a right element and a lower element. The structures of the inner holder 120 and the outer holder 130 in this case can also be designed on the basis of the undercut processing mechanism 16 according to the sixth embodiment.

While the first slide piece 141 is provided with the convex stripe 143 and the inner holder 120 is provided with the concave groove 126 in which the convex stripe 143 is fitted in the undercut processing mechanism 16 according to the sixth embodiment, the inner holder 120 may be provided with a convex stripe and the first slide piece 141 may be provided with a concave groove in which that convex stripe is fitted. This is also true for the convex stripe 128 on the inner holder 120 and the concave groove 134 in the outer holder 130 in which the convex stripe 128 is fitted. The fitted engagement between a convex stripe and concave groove may involve a dovetail feature. Alternatively, a convex stripe and a concave groove may even be dispensed with altogether.

Even in case of a molded article P4 with a first undercut portion in the form of the cylindrical boss P11 and second undercut portions in the form of the two holes P12, P13, the undercut processing mechanism 16 according to the sixth embodiment as described thus far allows for releasing of the undercut portions. With a molding die 1 integrated with the undercut processing mechanism 16, even a molded article having such a complex structure can be readily produced. Further, the undercut processing mechanism 16 is compact and can be provided as a single unit, thereby also facilitating its retrofitting to a pre-existing die.

Furthermore, since, when viewed in a front view, the inner holder 120 in the undercut processing mechanism 16 according to the sixth embodiment has a generally L-shaped configuration that includes a left element and a lower element and does not include a front element, a rear element, or a right element, the inner holder 120 can be provided in a reduced thickness (in directions along the z-axis). Therefore, a more compact undercut processing mechanism can be achieved.

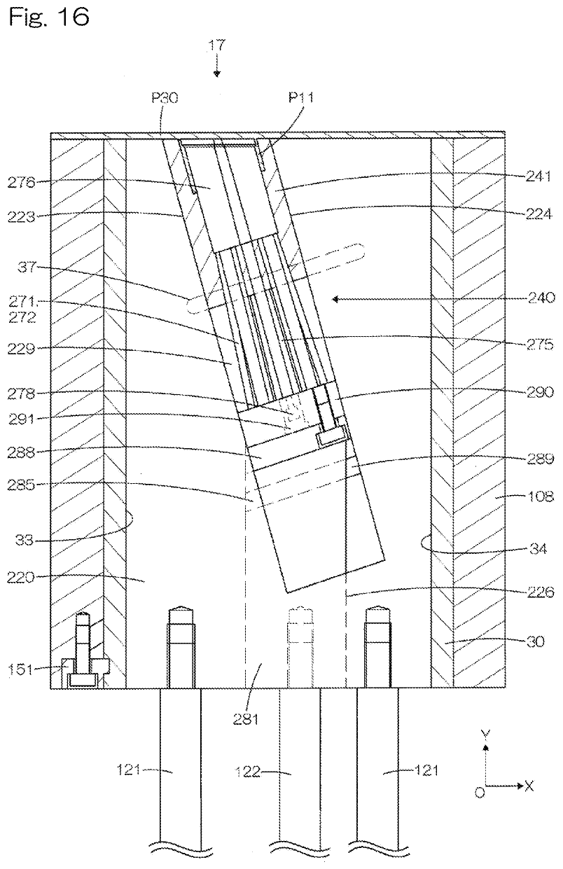

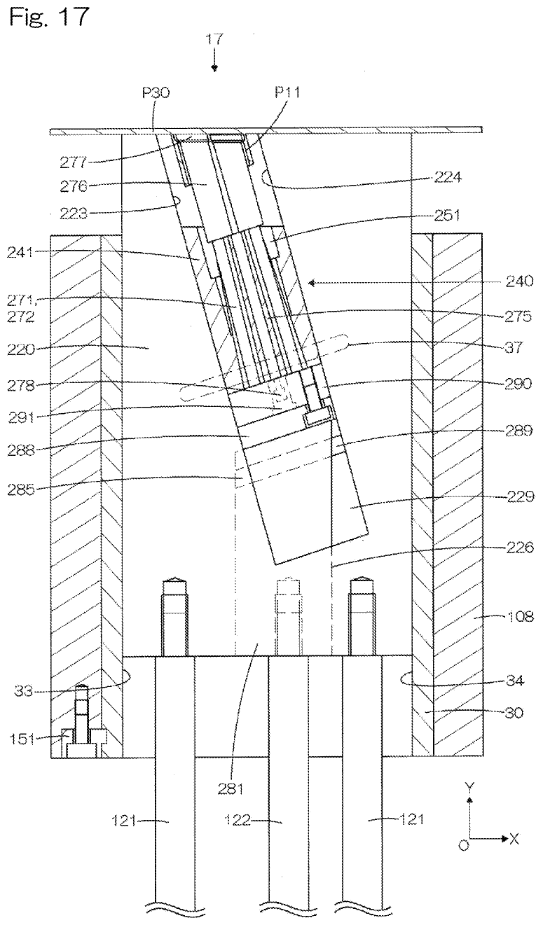

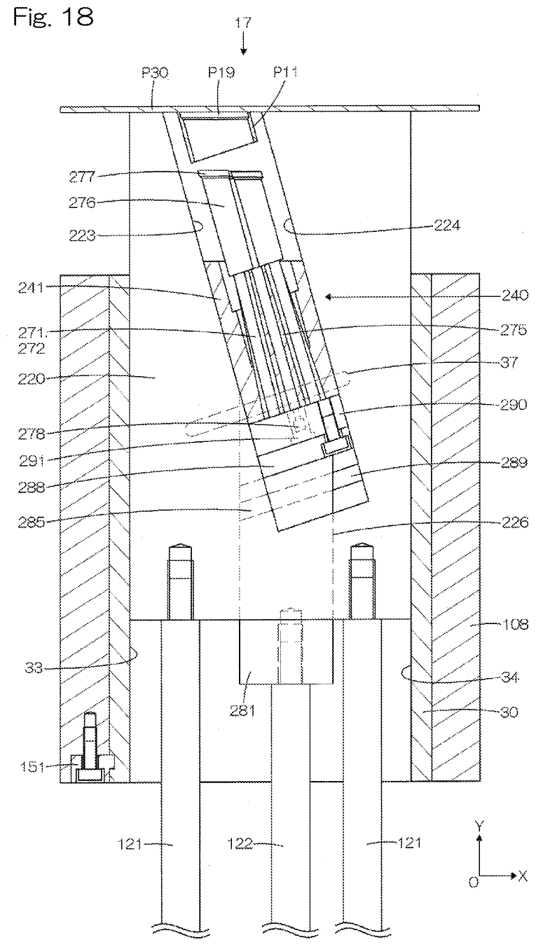

FIGS. 16, 17, and 18 are diagrams that illustrate the configuration of the undercut processing mechanism 17, according to the seventh embodiment of the present invention. FIG. 16 shows a front cross sectional view of the same during a molding phase for a molded article P30, while FIGS. 17 and 18 show front cross sectional views of the same during an ejection phase for the molded article P30. Among the features of the undercut processing mechanism 17 of the seventh embodiment according to the present invention, those equivalent to features of the undercut processing mechanism 11 according to the first embodiment shown in FIGS. 1 to 4 are indicated with the same reference symbols and will not be described for simplicity.

The undercut processing mechanism 17 is integrated into a molding die 1 to mold an article P30 having undercut portions P11, P19, just like the undercut processing mechanism 11. An article P30 to be molded with the aid of the undercut processing mechanism 17 includes a cylindrical boss P11 that forms a projection extending on an underside of the molded article P7 as a first undercut portion and an annular recess P19 extending on an inner side of the cylindrical boss P11 as a second undercut portion. A molding die 1 integrated with the undercut processing mechanism 17 according to the instant embodiment includes a two-step ejection feature.

The undercut processing mechanism 17 has a general configuration which is similar to that of the undercut processing mechanism 11 in that an inner holder 220, an outer holder 30, a slide piece 240, and a first carrier piece 281 are included, but differs from the undercut processing mechanism 11 by including a shrink-diameter mechanism configured to shape and release the second undercut portion in the form of the recess P19. The slide piece 240, the first carrier piece 281, the inner holder 220, and the outer holder 30 as components of the undercut processing mechanism 17 according to the instant embodiment correspond, respectively, to a slider, an interlock member, an inner holder, and an outer holder of a sliding mechanism according to the present invention. Moreover, a first slide piece 241 and a second slide piece 271 as components of the slide piece 240 correspond to slide members of a sliding mechanism according to the present invention.

The inner holder 220 corresponds to the inner holder 20 and is similar to the inner holder 20 in that the inner holder 220 receives the first slide piece 241 in a certain position during a die clamping phase for the molding die 1 and moves so as to eject the molded article P30 during a demolding phase for the same and in that the inner holder 220 includes a guide configured to guide the first slide piece 241 in such a way that decouples the first slide piece 241 from the cylindrical boss P11.

The inner holder 220 represents a block-shaped element having a generally U-shaped configuration when viewed in a front view, so as to provide a housing volume 229 extending from a center to a top side of the inner holder 220 for receiving the slide piece 240. In addition, the inner holder 220 has an insertion hole 226 which extends from the center to a bottom side of the inner holder 220 and in which the first slide piece 281 is slidably fitted. The insertion hole 226 and the housing volume 229 are in communication with each other. The housing volume 229 is also in communication with the top side of the inner holder 220, and the insertion hole 226 penetrates through the bottom side of the inner holder 220. While the inner holder 220 of the instant embodiment is open on a front side and a rear side of the housing volume 229, the front side and the rear side of the housing volume 229 may alternatively be closed by components arranged thereon.

Left and right inner wall surfaces 223, 224 of the inner holder 220 correspond to the left and right inner wall surfaces 23, 24 of the inner bolder 20 and provide slopes with which the first slide piece 241 is in slidable contact. The left and right inner wall surfaces 223, 224 are provided with concave grooves (not shown) in which convex stripes (not shown) provided on the first slide piece 241 are fitted. However, the concave grooves in the left and right inner wall surfaces 223, 224 and the convex stripes on the first slide piece 241 may be dispensed with.

The outer holder 30 used in the undercut processing mechanism 17 is analogous to the outer holder 30 used in the undercut processing mechanism 11 according to the first embodiment in terms of a structure and a function.

The slide piece 240 is similar to the slide piece 40 of the first embodiment in that the slide piece 240 includes the first slide piece 241 and the second slide piece 271. The second slide piece 271 comprises a plurality of split pieces 272.

The first slide piece 241 represents a block-shaped piece having a generally cuboidal outer profile and serves as an outer-surface molding piece configured to shape an outer side of the cylindrical boss P11. The first slide piece 241 includes an annular central cavity 251. The cavity 251 defines a housing for receiving mold portions 276 of the split pieces 272, with an outer circumferential surface serving as a mold surface for shaping an outer side of the cylindrical boss P11. The first slide piece 241 includes a central element which defines the cavity 251 and which also provides guide surfaces along which movements of the split pieces 272 are guided. The guide surfaces are each associated with a respective one of the split pieces 272 and are therefore provided as many as the split pieces 272.

Further, the first slide piece 241 has a bottom provided with guide channels providing access to the guide surfaces. The guide channels are in the form of through bores, are each associated with a respective one of the split pieces 272, and are therefore provided as many as the split pieces 272. The guide channels at the bottom of the first slide piece 241 play a role corresponding to the guide channel 50 provided in the inner-surface molding piece 42 of the first embodiment and have the split pieces 272 inserted therethrough.

Left and right outer wall surfaces of the first slide piece 241 provide slide surfaces with which the left and right inner wall surfaces 223, 224 of the inner holder 220 are in slidable contact, and are provided with the convex stripe (not shown) that are fitted in the concave grooves (not shown) provided in the inner wall surfaces 223, 224. In addition, outer wall surfaces on front and rear sides of the first slide piece 241 are provided with convex stripe (not shown) that are slidably fitted in guide grooves 37 in the outer holder 30. The convex stripe are equivalent to the convex stripe 48 provided on the base element 45 of the inner-surface molding piece 42 of the first embodiment.

The second slide piece 271 represents a piece configured to shape an inner circumferential surface of the cylindrical boss P11 containing the second undercut portion in the form of the recess 19 and comprises the plurality of split pieces 272. Just like the second slide piece 71 of the first embodiment, each of the split pieces 272 includes a rod-like main element 275, a mold portion 276 on a distal end of the rod-like main element 275, and a convex stripe 278 on a proximal end of the main element 275. The convex stripe 278 provided on the proximal end of the main element of each of the split pieces 272 is slidably fitted in an engagement groove in a respective one of elements of a second carrier piece 291.

The split pieces 272 comprise a first split piece and a second split piece that differ from each other in the shape of the mold portion 276. The mold portion 276 of the first split piece has a fan-like shape that is widened on the outside when viewed in a top plan view (i.e., in a plane parallel to a xz-plane). The mold portion 276 of the second split piece, on the other hand, has a triangular shape that is more narrowed on the outside than on the inside when viewed in a top plan view (i.e., in a plane parallel to a xz-plane). Only the first split piece is provided with a projection 277 configured to shape the second undercut portion in the form of the recess 19. The first split piece and the second split piece include respective sets of four elements that are alternately arranged in a circumferential direction. There is no specific limitation on the numbers of the elements of the first and second pieces, so long as they are configured to allow shrinkage of diameter.

The guide channels provided in the first slide piece 241 are provided such that the second split piece moves inwards (or towards a center) before the first split piece does. Such a configuration of the slide piece 240 allows the second split piece to move inwards first to create a space into which the first split piece can move as the second slide piece 271 is extended, thereby shrinking the diameter of the mold portion 276 as a whole.

While the second slide piece 71 of the first embodiment is in slidable engagement with the engagement groove 85 in the carrier piece 81 through the engagement pawl 78 provided on the proximal end of the main element 75 thereof, the second slide piece 271 of the seventh embodiment differs therefrom by changes made in the engagement feature of the second slide piece 271 with the carrier piece in order to adapt to the shape and structure of the second undercut portion. The undercut processing mechanism 17 according to the seventh embodiment includes a plurality of elements of the second carrier piece 291, in addition to the first carrier piece 281 which corresponds to the carrier piece 81 of the first embodiment.

The first carrier piece 281 has a top side provided with an engagement groove 285 in which a convex stripe 289 on a shrink-slide piece 288 is slidably fitted. Also, the first carrier piece 281 is similar to the carrier piece 81 of the first embodiment in that the first carrier piece 281 is coupled to a carrier piece ejector pin 122 and, during a demolding phase for the molded article P17, moves upwards (in a positive direction along the y-axis) so as to guide the second slide piece 271 via the shrink-slide piece 288 in such a way to decouple the second slide piece 271 from the second undercut portion P19.

Each of the second carrier pieces 291 includes a guide groove, with which the convex stripe 278 provided on the proximal end of the main element of a split piece 272 engages, such that the split piece 272 is guided in such a way to decouple itself from the second undercut portion in the form of the recess P19. The second carrier pieces 291 and the split pieces 272 are provided in the same number, and each of are each of the split pieces 272 engages with respective one of the second carrier piece 291.

Each of the second carrier piece 291 is mounted in a radial fashion to a second carrier piece retainer 290. The second carrier piece 291 mounted to the second carrier piece retainer 290 is each arranged in a radial fashion such that the guide groove provided in each of the second carrier piece 291 extends in a radial direction originating from a central point on the cylindrical boss P11. The second carrier piece retainer 290 is fixed to a top side of the shrink-slide piece 288. The second carrier pieces 291 may each be provided as one piece with the second carrier piece retainer 290 such that the second carrier piece retainer 290 directly provides the second carrier piece 291.

The shrink-slide piece 288 provides support for the second carrier piece retainer 290 to which the second carrier pieces 291 are mounted and also serves as a component coupling the second carrier piece retainer 290 to the first carrier piece 281. The shrink-slide piece 288 includes a main element supporting the second carrier piece retainer 290 to which the second carrier pieces 291 are mounted. Bottom side of the main element is provided with a convex stripe 289 that is slidably fitted in the engagement groove 285 provided in the first carrier piece 281. The shrink slide piece 288 may be provided as one piece with the second carrier piece retainer 290. Alternatively, it is possible to omit the shrink slide piece 288, and a bottom side of the second carrier piece retainer 290 may be provided with a convex stripe 289 which is slidably fitted in the engagement groove 285 provided in the first carrier piece 281.

In the foregoing undercut processing mechanism 17, the main element 275 of each of the split pieces 272 is fitted in a respective one of the guide channels provided in the first slide piece 241. The convex stripe 278 provided on the proximal end of the main element 275 of each of the split pieces 272 is fitted into a respective one of the second carrier piece elements 291. The second carrier piece elements 291 to which the split pieces 272 are coupled are, in turn, coupled to the second carrier piece retainer 290 and the shrink-slide piece 288. The first slide piece 241 and the second slide piece 271 are coupled in this way to make up the slide piece 240.

The slide piece 240 is fitted in the housing volume 229 of the inner holder 220. The convex stripe 289 provided on the shrink slide piece 288 is fitted in the engagement groove 285 in the first carrier piece 281 inserted into the insertion hole 226 in the inner holder 220. The slide piece 240 and the first carrier piece 281 that are integrated into the inner holder 220 are, in turn, assembled such that the convex stripe on the slide piece 240 fit in the guide grooves 37 in the outer holder 30. After the undercut processing mechanism 17 has thus been assembled into a single unit, the outer holder 30 is fixed to the movable die plate 108.

The inner holder 220 fixed to the movable die plate 108 is coupled to inner holder ejector pins 121, while the first carrier piece 281 is coupled to the carrier piece ejector pin 122. The inner holder ejector pins 121 and the carrier piece ejector pin 122 are, in turn, coupled to an ejector mechanism that includes the two-step ejection feature.

The ejector mechanism including the two-step ejection feature extends the inner holder ejector pins 121 upwards together with the carrier piece ejector pin 122 up to a first point, and after the first point is reached, continues to extend upwards only the inner holder ejector pins 121. The carrier piece ejector pin 122 is stopped at the first point reached. The first point in the instant embodiment is defined as a point which must be reached by the first carrier piece 281 to release the second undercut portion.

By way of example, for the ejector mechanism including the two-step ejection feature used in this context, a known two-step ejection-based, ejector mechanism can be employed such as, but not limited to, an ejector mechanism that comprises a first ejector plate to which the inner holder ejector pins 121 are attached, a second ejector plate to which the carrier piece ejector pin 122 is attached, and a magnet with which they are coupled to each other in a detachable manner.

The operation and effects of the undercut processing mechanism 17 will be described. During the molding phase for the article P3, the mold portions 276 of the split pieces 272 making up the second slide piece 271 are received in the first slide piece 241 in a position where they are closely packed and ready to shape the inner side of the cylindrical boss P11 and the recess P19. Thus, a cavity (or space) is created between the first slide piece 241 and the second slide piece 271, in which the cylindrical boss P11 containing the recess P19 is to be shaped (see FIG. 16).

The demolding of the molded article P30 and releasing of the undercut portions are performed in the following manner. Once the die opens, the inner holder 220 and the first carrier piece 281 are extended upwards (in a positive direction along the y-axis) simultaneously at the same speeds and for the same distances through the inner holder ejector pins 121 and the carrier piece ejector pin 122 to which they are coupled. In this way, the inner holder 220 ejects the molded article P30 upwards with the outer holder 30 serving as a guide therefor. Throughout this process, the positional relationship between the inner holder 220 and the first carrier piece 281 remains the same as prior to the ejection phase.

As the inner holder 220 moves up, the first slide piece 241 is guided along the left and right inner wall surfaces 223, 224 of the inner holder 220 with which it is slidable contact and the guide grooves 37 in the outer holder 30 in which the convex stripe thereon are slidably fitted, thus, causing the first slide piece 241 to be displaced along the guide grooves 37. This results in the first undercut portion in the form of the cylindrical boss P11 being released from the first slide piece 241 (see FIG. 17).

On the other hand, the second slide piece 271 which is coupled through the second carrier piece retainer piece 290 and the shrink slide piece 288 to the first carrier piece 281 moves in conjunction with the extension of the first carrier piece 281, and causes the mold portions 276 of the second slide piece 271 to protrude upwards relative to the first slide piece 241 (see FIG. 17). While this happens, the first split piece moves into a space created by the inward movement of the second split piece among the split pieces 272, thereby shrinking the diameter of the mold portions 276 as a whole. This allows the mold portions 276 of the second slide piece 271 to be decoupled from the second undercut portion in the form of the recess P19.

The point at which the mold portions 276 of the second slide piece 271 decouple from the second undercut portion in the form of the recess P19 is defined as the first point. Thus, thereafter, only the inner holder 220 moves up, leaving the first carrier piece 281 behind at that point. The inner holder 220 continues to move up and decouples the mold portions 276 of the second slide piece 271 from the cylindrical boss P11 by ejecting the molded article P30 in the demolding direction. It should be noted that, alternatively, after the first point is reached, the inner holder 220 and the first carrier piece 281 may move up at different speeds.

Even in case of a molded article P30 with a first undercut portion in the form of the cylindrical boss P11 and a second undercut portion in the form of the recess P19, the undercut processing mechanism 17 according to the seventh embodiment as described thus far allows for releasing of the undercut portions. With a molding die 1 integrated with the undercut processing mechanism 17, even a molded article having such a complex structure can be readily produced. Further, the undercut processing mechanism 17 is compact and can be provided as a single unit, thereby also facilitating its retrofitting to a pre-existing die.

While a sliding mechanism, an undercut processing mechanism, a molding die, and a molded article according to the present invention have thus far been described with reference to the molding dies 1 and the undercut processing mechanisms 11, 12, 13, 14, 15, 16, 17 according to the first to seventh embodiments, these embodiments are only a subset of non-limiting examples of a sliding mechanism, an undercut processing mechanism, a molding die, and a molded article according to the present invention and can be put into use upon modifications which do not deviate from their general principles.

The molded articles presented according to the first to seventh embodiments are only a subset of non-limiting examples of articles that can be molded with the aid of an undercut processing mechanism and a molding die according to the present invention. A wide variety of articles with a first undercut portion which forms a projection extending along a direction that forms a crossing angle to an article demolding direction and a second undercut portion provided in or at the first undercut portion and defining a releasing direction that is different from the article demolding direction and a releasing direction of the first undercut portion can be molded. The second undercut portion in this context may comprise a single undercut portion or more than one undercut portion.

While the undercut processing mechanisms 11, 12 according to the first and second embodiments are intended for a molded article P1 having a cylindrical boss P11 with a single hole P12 and the undercut processing mechanisms 13, 14, 16 according to the third, fourth, and sixth embodiments are intended for molded articles P3, P4 having a cylindrical boss P11 with two holes P12, P13, molded articles having a cylindrical boss P11 with at least three holes can also be produced with a molding die including an undercut processing mechanism according to the present invention.

While the second undercut portion comprises a hole in the case of the undercut processing mechanisms 11, 12, 13, 14, 16 according to the first, second, third, fourth, and sixth embodiments, the hole may be replaced with a recess or the second undercut portion may even comprise more than one hole and more than one recess. Further, the undercut portion may comprise a protrusion in the context of an undercut processing mechanism according to the present invention.

If an article having a cylindrical boss P11 with three or more holes is to be molded with two of the holes being colinearly arranged, a second slide piece 71 having a mold portion 76 which is provided with a corresponding number of protrusions 77 arranged in a corresponding arrangement can be provided.

Now let us consider an example in which an article having a cylindrical boss P11 with three or more holes is to be molded with the holes being arranged in a circumferential direction. For instance, if the article is provided with four holes spaced apart from each other by 90 degrees in a circumferential direction, a single unit of the second slide piece 71 and a single unit of the engagement groove 85 which is provided in the carrier piece 81 in engagement with the second slide piece 71 can be positioned in every 90 degrees—a total of four units per each. In this case, the engagement groove 85 whose guidance brings the protrusions 77 on the second slide pieces 71 out of engagement with the holes may all be arranged in a single carrier piece 81 in a radial fashion. Alternatively, four carrier pieces 81, each with a single engagement groove 85, may be provided.

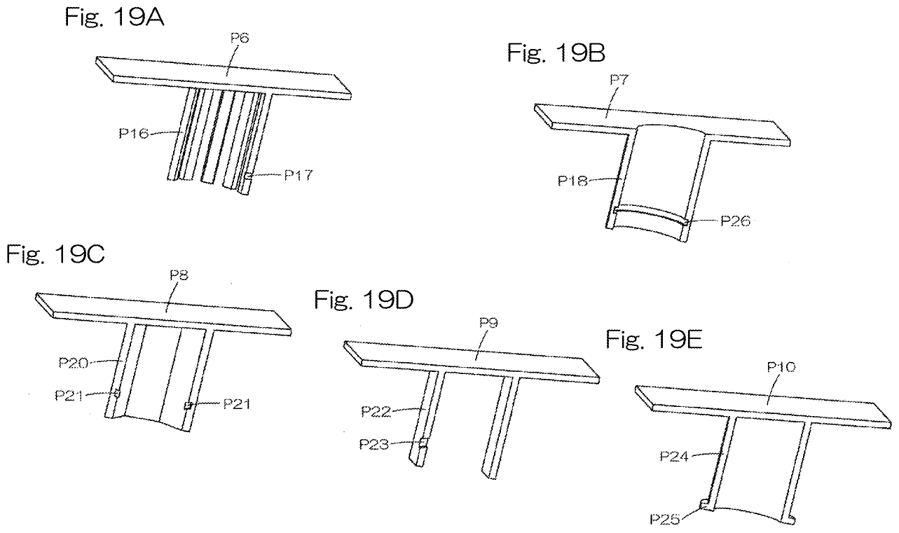

FIGS. 19A to 19E show a set of diagrams which illustrate other examples of articles that can be molded with the use of an undercut processing mechanism and a molding die according to the present invention. In FIG. 19A, the first undercut portion forming a projection extending along a direction that forms a crossing angle to the demolding direction of a molded article P6 comprises a semicircular boss P16 having a plurality of slits provided therein. In addition, the second undercut portion comprises a recess P17 provided at an edge of the semicircular boss P16. In FIG. 19B, the first undercut portion forming a projection extending along a direction that forms a crossing angle to the demolding direction of a molded article P7 comprises a semicircular boss P18. The second undercut portion comprises a recess P26 provided on an inner side of the semicircular boss P18.

In FIG. 19C, the first undercut portion forming a projection extending along a direction that forms a crossing angle to the demolding direction of a molded article P8 comprises a boss P20 including three planar elements connected together in an angled manner. The second undercut portion comprises recesses P21 provided at opposite edges of the boss P20. In FIG. 19D, the first undercut portion forming a projection extending along a direction that forms a crossing angle to the demolding direction of a molded article P9 comprises two planar elements P22 arranged parallel to and spaced apart from each other. The second undercut portion comprises a recess p23 provided at an edge face of one of the planar elements 22. In FIG. 19F, the first undercut portion forming a projection extending along a direction that forms a crossing angle to the demolding direction of a molded article P10 comprises a semicircular boss P24. The second undercut portion comprises a flange P25 provided so as to project outwards from the boss P24.

Furthermore, an article formed of a confronting arrangement of molded articles from among those shown in FIGS. 19A to 19E in a manner that exhibits mirror symmetry and an article formed of a molded article from among those shown in FIGS. 19A to 19E in combination with a further planar element or another type of element can also be molded with the aid of an undercut processing mechanism and a molding die according to the present invention.

An article to be molded may include a first undercut portion in the form of a cylindrical boss P11, second undercut portions in the form of holes P12, P13 provided in the first undercut portion P11, and a third undercut portion in the form of a flange P15 further provided on the first undercut portion P11 and/or fourth and fifth undercut portions provided in or at the first undercut portion P11 with further different releasing directions. Such a molded article can also be produced with the aid of an undercut processing mechanism and a molding die according to the present invention.

Furthermore, a molded article including a main body of the article with at least two sets of a first undercut portion and a second undercut portion provided in or at the first undercut portion can also be produced with the aid of an undercut processing mechanism and a molding die according to the present invention. The first undercut portions in this case may form projections extending along different directions. When they define different releasing directions, they may be assigned with different undercut processing mechanisms with holders, slide piece(s), and carrier piece(s) having respective limiters, such as a slanting groove, a dovetail, and/or a convex stripe, that are configured with appropriate slanting angles so as to allow for releasing of corresponding undercut portion(s).

While the outer holders 30, 130 are provided with the guide grooves 37, 137 that delimit the direction of movements of the first slide pieces 41, 141 in the undercut processing mechanisms 11, 13, 14, 16, 17 according to the first, third, fourth, sixth, and seventh embodiments, the outer holders 30, 130 may be omitted by providing the guide grooves 37, 137 in the movable die 101 and/or the movable die plate 108.

Each of the carrier piece and the slide piece may be formed of a plurality of components in an undercut processing mechanism and a molding die according to the present invention, as an alternative to a non-limiting example in which each of them is formed of a single component. When they are formed of a plurality of components, the components may be connected through, for example, a bolt or a dowel pin, or may even be joined together without using such a bolt, a dowel pin, etc. It should be noted that this is true not only for a carrier piece or slide piece, but also for each component of a sliding mechanism and a molding die according to the present invention.

Also, the inner holder and the carrier piece may be provided not as distinct components but as one piece in an undercut processing mechanism and a molding die according to the present invention. Further, the inner holder and the carrier piece may not be fastened to each other and may be configured to be separately extended in an undercut processing mechanism and a molding die according to the present invention. Furthermore, the shape of the outer holder and the shapes of the undercut portions described herein are only a subset of non-limiting examples thereof in an undercut processing mechanism and a molding die according to the present invention.

Moreover, the slide piece configured to shape an undercut portion in an undercut processing mechanism according to the present invention may move or may be provided with a protrusion that moves in a direction not parallel to a releasing direction of an undercut portion when decoupling or disengaging itself from the undercut portion, instead of moving parallel to the releasing direction of the undercut portion.

The inner holders 20 in the undercut processing mechanisms according to the foregoing embodiments are positioned such that the top sides thereof come into contact with the underside of molded articles P1 during a molding phase for the same, as is representatively shown by the undercut processing mechanism 11 according to the first embodiment. This means that the top sides of the inner holders 20 serve as mold surfaces. However, the inner holder and the outer holder in an undercut processing mechanism according to the present invention may be designed not to define a mold surface for an article being molded. When the top side of the inner holder is not designed to come into contact with an article being molded during a molding phase such that the inner holder does not participate in the ejection of the molded article during a demolding phase for the same, the ejection of the molded article may be performed through an ejector pin, an ejection block, or another type of ejection feature that is dedicated to the ejection of the molded article, while the inner holder and the carrier piece may be configured to move in conjunction or in an interlocking manner therewith so as to decouple the slide piece from an undercut portion.

While guide grooves, slanting grooves, engagement grooves, and convex stripe as well as engagement pawls that engage therewith are presented as the guiding sections that delimit directions of movements in the undercut processing mechanisms according to the first to seventh embodiments, the positional relationship between the guide grooves, slanting grooves, and engagement grooves on one hand and the convex stripe and engagement pawls on the other hand may be inverted in those embodiments. By way of example, while the main element 75 of the second slide piece 71 is provided with the engagement pawl 78 and the carrier piece 81 is provided with the engagement groove 85 with which the engagement pawl 78 is in slidable engagement in the undercut processing mechanism 11 according to the first embodiment, the main element 75 of the second slide piece 71 may be provided with the engagement groove while the carrier piece 81 may be provided with the engagement pawl.

The cross section of the mutual engagement between a guide groove, a slanting groove, or an engagement groove and a convex stripe or an engagement pawl can be rectangular in shape in a non-limiting example and may, therefore, have any given shape composed of a circle, a triangle, a polygon, a straight line, and/or a curve which may be joined together in a way that provides a dovetail feature. Moreover, for example, a linear guide may be adopted between a guide groove, a slanting groove, or an engagement groove and a convex stripe or an engagement pawl that are in mutual engagement.

Basically, regarding a guiding section, essentially no clearance exists between a guide groove, a slanting groove, or an engagement groove and a convex stripe or an engagement pawl in slidable engagement therewith or—as represented by the undercut processing mechanism according to the first embodiment—between the inner wall surfaces 23, 24 on the inner holder 20 and the wall surfaces 46, 47 of the first slide piece 41, and the like. However, the contact between the guide groove, the slanting groove, or the engagement groove and the convex stripe or the engagement pawl or between the slide surfaces may take place in portions or at temporal intervals, so long as the originally intended function of providing guidance along directions of movements or delimiting such directions of movements can be achieved by these guiding sections.

Also, each component of a sliding mechanism, an undercut processing mechanism, and a molding die according to the present invention may be, for example, bullnosed or chamfered at a corner or a side edge.

Further, the material for components used in a sliding mechanism, an undercut processing mechanism, and a molding die according to the present invention is not limited to a specific material. A material having similar characteristics to that used in the components of a known undercut processing mechanism and molding die can be employed as appropriate. However, it is preferred that the material used for a slide surface of a given component comprises a material exhibiting good slidability or has a surface processed with a treatment that improves the slidability thereof. It should be noted that a given slide surface can be based on, but not limited to, surface contact and may, therefore, be based on line contact or point contact as an alternative.

There is no specific limitation to the direction of movement of a piece, the direction of ejection of a molded article, and the direction of opening and closing of a molding die in the context of an undercut processing mechanism and a molding die according to the present invention. Hence, an undercut processing mechanism according to the present invention can also be applied to molding dies configured to open and close in a horizontal direction, a vertical direction, or another direction.

The material to be handled by a sliding mechanism according to the present invention and the material of an article to be molded in a molding die with an undercut processing mechanism according to the present invention can be, but not limited to, a synthetic resin such as a plastic and may, therefore, be a metal such as iron, copper, and aluminum or, otherwise, a composite material.

A sliding mechanism, an undercut processing mechanism, and a molding die according to the present invention can be suitably applied to injection molding dies and other molding dies such as die casting dies and press molding dies.

While preferred embodiments have thus been discussed with reference to the drawings, a person skilled in the art who read the specification would readily conceive of various changes and modifications to the extent that they are evident therefrom. Accordingly, such changes and modifications should be construed as falling within the scope of the present invention as delimited by the appended claims.

### REFERENCE SYMBOLS

1 . . . molding die
11, 12, 13, 14, 15, 16, 17 . . . undercut processing mechanism
20, 22, 120, 220 . . . inner holder
23, 24, 223, 224 . . . inner wall surface
30, 130 . . . outer holder
33, 35, 133, 135 . . . inner wall surface
37, 39, 137 . . . guide groove
38 . . . slope
40, 140, 240 . . . slide piece
41, 141, 241 . . . first slide piece
42 . . . inner-surface molding piece
48, 148 . . . convex stripe
49 . . . engagement pawl
50, 52, 56 . . . guide channel
51, 53, 55 . . . valley
58, 59 . . . outer-surface molding piece
60 . . . mold piece
62 . . . mold surface
64, 86, 96 . . . convex stripe
65 . . . guide groove
71, 72, 73, 271 . . . second slide piece
76, 276 . . . mold portion
77 . . . protrusion
78 . . . engagement pawl
81, 82, 181, 281 . . . carrier piece
85, 285 . . . engagement groove
90, 92 . . . guide piece
91, 95 . . . guide groove
96 . . . convex stripe
100 . . . fixed die
101 . . . movable die
110 . . . ejector plate
121 . . . inner holder ejector pin
122 . . . carrier piece ejector pin
125 . . . right wall surface
127 . . . left wall surface
142 . . . left side surface
144 . . . right side surface
272 . . . split piece
291 . . . second carrier piece
C . . . central axis
P1, P3, P4, P5, P6, P7, P8, P9, P10, P30 . . . molded article
P11 . . . first undercut portion, cylindrical boss
P12, P13 . . . undercut portion, hole
P15 . . . undercut portion, flange
P16, P18, P20, P22, P24 . . . first undercut portion, boss
P17, P19, P21, P23, P25, P26 . . . second undercut portion, recess

1. A sliding mechanism comprising:
a slider movable along a predetermined direction;
an interlock member in engagement with the slider, movable along a first direction, and including a guiding section configured to guide the slider along the predetermined direction;
an inner holder movable along the first direction and including a guiding section configured to guide the slider along the predetermined direction; and
an outer holder including a guiding section configured to guide the slider along the predetermined direction and a guiding section configured to guide the inner holder along the first direction,
the inner holder being configured to move in such a way that the inner holder is displaced relative to the outer holder.

2. The sliding mechanism as claimed in claim 1, wherein the inner holder is configured to be able to slidably receive a part or entirety of the slider, and the outer holder is configured to be able to slidably receive a part or entirety of the inner holder.

3. The sliding mechanism as claimed in claim 1, wherein the inner holder and the outer holder are configured to cooperate to slidably receive a part or entirety of the slider.

4. The sliding mechanism as claimed in claim 1, wherein the predetermined direction is different from the first direction.

5. The sliding mechanism as claimed in claim 1, wherein the slider includes two or more slide members, and the predetermined direction is different among at least two of the slide members.

6. The sliding mechanism as claimed in claim 1, wherein the interlock member and the inner holder are configured to be movable at the same timings, at the same speeds, and for the same distances.

7. The sliding mechanism as claimed in claim 1, wherein the interlock member is fixed to the inner holder or is of one piece construction with the inner holder.

8. The sliding mechanism as claimed in claim 1 wherein the interlock member and the inner holder are configured to move together in an interlocking manner up to a predefined first point, and once the first point is reached, the interlock member and the inner holder are configured to move relatively at different speeds or the interlock member is configured to be stopped while only the inner holder is configured to be able to further move.

9. The sliding mechanism as claimed in claim 1, further comprising, in place of the outer holder, a guide piece in slidable engagement with the slider and including a guiding section configured to guide the slider along the predetermined direction.

10. The sliding mechanism as claimed in claim 1, wherein the sliding mechanism is assembled as a single unit.

11. An undercut processing mechanism comprising:
a sliding mechanism as claimed in claim 1, the sliding mechanism being configured to disengage a mold portion configured to shape an undercut portion in an article being molded, from the undercut portion.

12. The undercut processing mechanism as claimed in claim 11,
wherein the undercut processing mechanism is configured to be installed to and used with a molding die that molds an article having an undercut portion, the first direction is a demolding direction of the molded article,
the predetermined direction is a releasing direction of the undercut portion,
the slider comprises a slide piece including the mold portion configured to shape the undercut portion,
the interlock member comprises a carrier piece in slidable engagement with the slide piece, movable along the demolding direction of the molded article, and including a guiding section configured to guide the slide piece along the releasing direction of the undercut portion, and
the slide piece is configured to move in conjunction with movements of the inner holder and the carrier piece in the demolding direction of the molded article, so as to decouple itself from the undercut portion.

13. The undercut processing mechanism as claimed in claim 12,
wherein the undercut portion includes a first undercut portion defining a releasing direction that forms a crossing angle to the demolding direction of the molded article and a second undercut portion defining a releasing direction that is different from the demolding direction of the molded article and the releasing direction of the first undercut portion, and
the slide piece includes a first slide piece including a mold portion configured to shape the first undercut portion and a second slide piece including a mold portion configured to shape the second undercut portion.

14. The undercut processing mechanism as claimed in claim 13,
wherein the first undercut portion forms a projection extending along a direction that forms a crossing angle to the demolding direction of the molded article, and the second undercut portion is provided in or at the first undercut portion.

15. The undercut processing mechanism as claimed in claim 13,
wherein the mold portion of the second slide piece comprises a mold portion configured to shape a part of the first undercut portion, and
the first slide piece and the second slide piece are configured to cooperate to shape the first undercut portion.

16. The undercut processing mechanism as claimed in claim 13,
wherein the guiding sections provided at the inner holder and the outer holder for guidance along the predetermined direction are configured to guide the first slide piece in such a direction that decouples the first slide piece from the first undercut portion, and
the inner holder is configured to move in the demolding direction of the molded article so as to eject the molded article and cause the first slide piece to move away from the first undercut portion to thereby decouple the first slide piece from the first undercut portion.

17. The undercut processing mechanism as claimed in claim 13,
wherein the releasing direction of the second undercut portion forms a crossing angle to the releasing direction of the first undercut portion, and
the inner holder and the carrier piece are configured to move in the demolding direction of the molded article so as to cause a movement of the second slide piece in the demolding direction of the molded article, during which the second slide piece is decoupled from the second undercut portion.

18. The undercut processing mechanism as claimed in claim 13,
wherein the first slide piece includes a guiding section configured to guide a movement of the second slide piece in such a way that causes the second slide piece to decouple itself from the second undercut portion.

19. The undercut processing mechanism as claimed in claim 13,
wherein the second undercut portion includes one or at least two undercut portions,
the second slide piece comprises one or at least two mold pieces configured to shape the one or at least two undercut portions,
the carrier piece comprises a guiding section configured to guide a movement of the mold piece so as to decouple the mold piece from the second undercut portion, and
the inner holder and the carrier piece are configured to move in the demolding direction of the molded article so as to cause the mold piece or pieces to move in such a way that decouples itself or themselves from the second undercut portion.

20. The undercut processing mechanism as claimed in claim 13,
wherein the second slide piece comprises two or more split pieces, and
at least two of the split pieces are configured to move along different directions that are also different from a direction or directions along which the inner holder and the carrier piece move.

21. The undercut processing mechanism as claimed in claim 13,
wherein the second slide piece comprises a plurality of split pieces, and the split pieces are configured to move in such a way to shrink and allow the undercut portion or undercut portions to be released.

22. The undercut processing mechanism as claimed in claim 13,
wherein the carrier piece and the inner holder are configured to move together in an interlocking manner in the demolding direction of the molded article until the second slide piece decouples from the second undercut portion, and
once the second slide piece decouples from the second undercut portion, the carrier piece and the inner holder are configured to move in the demolding direction of the molded article relatively at different speeds or the carrier piece is configured to be stopped while only the inner holder is configured to be able to further move in the demolding direction of the molded article.

23. The undercut processing mechanism as claimed in claim 13,
wherein the first slide piece concurrently serves as the second slide piece such that the first slide piece includes both the mold portion configured to shape the first undercut portion and the mold portion configured to shape the second undercut portion.

24. The undercut processing mechanism as claimed in claim 13,
wherein the inner holder and the first slide piece provide a coupling feature defined by a concave groove and a convex stripe fitted slidably in the concave groove such that the inner holder and the first slide piece are slidably coupled to each other through the coupling feature, and
the inner holder and the outer holder provide a coupling feature defined by a concave groove and a convex stripe fitted slidably in the concave groove such that the inner holder and the outer holder are slidably coupled to each other through the coupling feature.

25. The undercut processing mechanism as claimed in claim 11,
wherein the undercut processing mechanism is assembled as a single unit.

26. A molding die, comprising an undercut processing mechanism as claimed in claim 11.

27. A molded article comprising a main body of the article and a part including an undercut portion,
the undercut portion including a first undercut portion defining a releasing direction and forming a projection extending along a direction that forms a crossing angle to a demolding direction of the molded article and a second undercut portion provided at least in or at the first undercut portion and defining a releasing direction that is different from the releasing direction of the first undercut portion,
the main body of the article and the part including the undercut portion being integrally molded in a molding die such that a cross-section of the molded article at a boundary between the main body of the article and a region of the first undercut portion contains no seam mark present therebetween.
